(19) United States
(12) Patent Application Publication
(10) Pub. No.: US 2026/0124875 A1
(43) Pub. Date: May 7, 2026

(54) HEAT PUMP CYCLE DEVICE

(71) Applicant: DENSO CORPORATION, Kariya-city, (JP)

(72) Inventors: Kiyoshiro OTA, Kairya-city (JP); Kengo SUGIMURA, Kariya-city (JP); Yuichi KAMI, Kariya-city (JP)

(21) Appl. No.: 19/436,793

(22) Filed: Dec. 30, 2025

Related U.S. Application Data
(63) Continuation of application No. PCT/JP2024/018517, filed on May 20, 2024.

(30) Foreign Application Priority Data
Jul. 3, 2023 (JP) 2023-109418

(51) Int. Cl. B60H 1/00

(52) U.S. Cl. CPC B60H 1/00914

(57) ABSTRACT

A heat pump cycle device includes a control unit that executes control switching between a first heating mode and a second heating mode. In the first heating mode, all refrigerant discharged from a compressor flows into a heating unit via a branch portion. In the second heating mode, a part of the refrigerant discharged from the compressor flows into a bypass passage via the branch portion to be merged with the refrigerant flowing from the heating unit. When switching from the first heating mode to the second heating mode, the control unit executes a limiting operation of limiting an amount of released heat in the heating unit in the first heating mode to a low level, and completes the switching to the second heating mode after executing the limiting operation.

### CROSS REFERENCE TO RELATED APPLICATIONS

The present application is a continuation application of International Patent Application No. PCT/JP2024/018517 filed on May 20, 2024, which designated the U.S. and claims the benefit of priority from Japanese Patent Application No. 2023-109418 filed on Jul. 3, 2023. The disclosures of all the above applications are incorporated herein.

### TECHNICAL FIELD

The present disclosure relates to a heat pump cycle device.

### BACKGROUND

Conventionally, techniques have been developed in which a heat pump cycle device is applied to vehicle air conditioners, enabling a heat pump heating mode that heats a heating target using heat absorbed from an external heat absorption source.

### SUMMARY

According to a first aspect of the present disclosure, a heat pump cycle device includes a compressor, a branch portion, a heating unit, a low temperature decompression unit, a bypass passage, a bypass decompression unit, a merging portion, a heat absorption unit, and a control unit. The compressor is configured to compress and discharge a refrigerant. The branch portion is configured to branch a flow of the refrigerant discharged from the compressor. The heating unit is configured to heat a heating target using the refrigerant flowing out of one outflow port of the branch portion as a heat source. The low temperature decompression unit is configured to decompress the refrigerant flowing out of the heating unit. The bypass passage is configured to allow another portion of the refrigerant branched at the branch portion to flow through the bypass passage. The bypass decompression unit is configured to adjust a flow rate of the refrigerant flowing through the bypass passage. The merging portion is configured to merge a flow of the refrigerant flowing out of the bypass decompression unit and a flow of the refrigerant flowing out of the low temperature decompression unit to flow out toward a suction port of the compressor. The heat absorption unit is configured to cause at least the refrigerant flowing out of the low temperature decompression unit to absorb heat of a heat absorption target. The control unit includes a processor with a memory storing a program configured to cause the processor to execute control switching between a first heating mode and a second heating mode. The first heating mode is configured to cause all of the refrigerant discharged from the compressor to flow into the heating unit via the branch portion, and pump up heat absorbed from the heat absorption target in the heat absorption unit to heat the heating target. The second heating mode is configured to cause a part of the refrigerant discharged from the compressor to flow into the bypass passage via the branch portion, and guide the refrigerant flowing out of the bypass decompression unit to the merging portion. Simultaneously, the second heating mode is configured to cause another part of the refrigerant discharged from the compressor to flow into the heating unit via the branch portion, and cause the refrigerant flowing out of the heating unit to merge with a flow of the refrigerant from the bypass decompression unit at the merging portion to be sucked into the compressor. The control unit is configured to, when switching from the first heating mode to the second heating mode, execute a limiting operation of limiting an amount of released heat in the heating unit in the first heating mode to a low level, and complete the switching to the second heating mode after executing the limiting operation.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a configuration diagram of a heat pump cycle device according to a first embodiment.

FIG. 2 is a configuration diagram of an interior air conditioning unit according to the first embodiment.

FIG. 3 is a block diagram illustrating a control system of the heat pump cycle device according to the first embodiment.

FIG. 4 is a Mollier diagram of the heat pump cycle device according to the first embodiment during a heat pump heating.

FIG. 5 is a Mollier diagram of the heat pump cycle device according to the first embodiment during a hot gas heating.

FIG. 6 is an explanatory diagram illustrating an example of switching control of the heat pump cycle device according to the first embodiment.

FIG. 7 is a configuration diagram of a heat pump cycle device according to a second embodiment.

FIG. 8 is an explanatory diagram illustrating a first state in switching control of the heat pump cycle device according to the second embodiment.

FIG. 9 is an explanatory diagram illustrating a second state in switching control of the heat pump cycle device according to the second embodiment.

FIG. 10 is a configuration diagram of a heat pump cycle device according to a third embodiment.

FIG. 11 is an explanatory diagram illustrating a first state in switching control of the heat pump cycle device according to the third embodiment.

FIG. 12 is an explanatory diagram illustrating a second state in switching control of a heat pump cycle according to the third embodiment.

FIG. 13 is a configuration diagram of a heat pump cycle device according to a fourth embodiment.

FIG. 14 is an explanatory diagram of an operation of the heat pump cycle device according to the fourth embodiment during an independent circulation heating.

FIG. 15 is an explanatory diagram of an operation of the heat pump cycle device according to the fourth embodiment during a circuit cooperation heating.

FIG. 16 is an explanatory diagram illustrating an example of switching control of the heat pump cycle device according to the fourth embodiment.

### DETAILED DESCRIPTION

According to a comparative example, a heat pump cycle device is applied to a vehicle air conditioner, enabling a heat pump heating mode that heats a heating target using heat absorbed from an external heat absorption source. Specifically, in the heat pump heating mode, blown air is a heating target to be heated and supplied to a vehicle compartment.

The heating capacity in the heat pump heating mode is affected by a heat absorption amount from the heat absorption source. Thus, when the heat absorption amount capable of absorbing heat from the heat absorption source is lower than a required heating capacity, the heating target may not be sufficiently heated. For example, in a case where outside air is used as the heat absorption source, sufficient heating capacity (that is, air heating performance) cannot be achieved in environments where the outside air temperature is low.

In such a case, the heat pump cycle device adopts an operation mode in which the amount of work done by the compressor is increased using a part of the heat of the high-pressure refrigerant discharged from the compressor to exert the heating capacity of the heating target.

The vehicle air conditioner of the comparative example is switchable between a heat pump heating mode corresponding to the heat pump heating mode and a hot gas heating mode. The hot gas heating mode is an operation mode in which a part of the refrigerant discharged from the compressor is bypassed to the low-pressure flow path to increase the amount of work of the compressor itself and exert the heating capacity of the heating target (that is, the blown air).

If the heat pump heating mode is simply switched to the operation mode in which the amount of work done by the compressor is increased using part of the heat of the refrigerant discharged from the compressor to increase the heating capacity, reduction in the heating capacity supplied to the heating target can be expected.

For example, in the hot gas heating mode, the heating capacity delivered to the heating target is determined by the amount of work performed by the compressor. The work performed by the compressor is proportional to the refrigerant flow rate within the compressor, and the refrigerant flow rate is, in turn, proportional to the suction density of the refrigerant entering the compressor. Therefore, to increase the heating capacity in the hot gas heating mode, it is important to increase the suction density of the refrigerant into the compressor. In other words, it is necessary to raise the suction pressure of the refrigerant in the compressor.

On the other hand, in the heat pump heating mode, the heating capacity supplied to the heating target depends on the amount of heat absorbed by the heat absorber. This heat absorption amount is determined by the temperature difference between the low-pressure refrigerant flowing through the heat absorber and the heat absorption target. Therefore, to increase the heating capacity in the heat pump heating mode, it is necessary to reduce the pressure of the low-pressure refrigerant in the heat absorber as much as possible relative to a reference based on the temperature of the heat absorption target.

As described above, in the hot gas heating mode, the higher the pressure of the low-pressure refrigerant in the cycle, the more the heating capacity can be secured. On the other hand, in the heat pump heating mode, the lower the pressure of the low-pressure refrigerant in the cycle, the more the heating capacity can be secured.

When switching between the heat pump heating mode and the hot gas heating mode, which have opposing characteristics, fluctuations in heating capacity may occur due to differences in their required operating conditions. For example, if the system is switched from the heat pump heating mode to the hot gas heating mode while the pressure of the low-pressure refrigerant is low, the resulting heat output may be insufficient to meet the heating capacity required for hot gas heating, causing heating capacity to fluctuate during the mode transition. Furthermore, in the hot gas heating mode initiated under these conditions, it is necessary to raise the pressure of the low-pressure refrigerant to compensate for the deficit. As a result, there may be a period during which the heating capacity remains insufficient until the system achieves a heating capacity equivalent to that prior to switching.

In contrast, according to the present disclosure, a heat pump cycle device is capable of suppressing a fluctuation in heating capacity at the time of switching from a heat pump heating mode to an operation mode for exerting the heating capacity using part of heat of a high-pressure refrigerant discharged from a compressor.

According to a first aspect of the present disclosure, a heat pump cycle device includes a compressor, a branch portion, a heating unit, a low temperature decompression unit, a bypass passage, a bypass decompression unit, a merging portion, a heat absorption unit, and a control unit.

The compressor is configured to compress and discharge a refrigerant. The branch portion is configured to branch a flow of the refrigerant discharged from the compressor. The heating unit is configured to heat a heating target using the refrigerant flowing out of one outflow port of the branch portion as a heat source. The low temperature decompression unit is configured to decompress the refrigerant flowing out of the heating unit. The bypass passage is configured to allow another portion of the refrigerant branched at the branch portion to flow through the bypass passage. The bypass decompression unit is configured to adjust a flow rate of the refrigerant flowing through the bypass passage. The merging portion is configured to merge a flow of the refrigerant flowing out of the bypass decompression unit and a flow of the refrigerant flowing out of the low temperature decompression unit to flow out toward a suction port of the compressor. The heat absorption unit is configured to cause at least the refrigerant flowing out of the low temperature decompression unit to absorb heat of a heat absorption target.

The control unit is configured to execute control switching between a first heating mode and a second heating mode. The first heating mode is configured to cause all of the refrigerant discharged from the compressor to flow into the heating unit via the branch portion, and pump up heat absorbed from the heat absorption target in the heat absorption unit to heat the heating target. The second heating mode is configured to cause a part of the refrigerant discharged from the compressor to flow into the bypass passage via the branch portion, and guide the refrigerant flowing out of the bypass decompression unit to the merging portion. Simultaneously, the second heating mode is configured to cause another part of the refrigerant discharged from the compressor to flow into the heating unit via the branch portion, and cause the refrigerant flowing out of the heating unit to merge with a flow of the refrigerant from the bypass decompression unit at the merging portion to be sucked into the compressor.

The control unit is configured to, when switching from the first heating mode to the second heating mode, execute a limiting operation of limiting an amount of released heat in the heating unit in the first heating mode to a low level, and complete the switching to the second heating mode after executing the limiting operation.

Therefore, according to the heat pump cycle device according to the first aspect, the limiting operation is executed when switching from the first heating mode to the second heating mode, reducing the amount of released heat released from the refrigerant in the heating unit. As a result, the heat content of the refrigerant immediately before switching to the second heating mode can be increased. Consequently, the heat pump cycle device according to the first aspect can minimize the difference between the heating capacity in the first heating mode and the heating capacity in the second heating mode, thereby suppressing fluctuations in heating capacity.

According to a second aspect of the present disclosure, a heat pump cycle device includes a compressor, a branch portion, a heating unit, a low temperature decompression unit, a bypass passage, a bypass decompression unit, a merging portion, a heat absorption unit, and a control unit.

The compressor is configured to compress and discharge a refrigerant. The branch portion is configured to branch a flow of the refrigerant discharged from the compressor. The heating unit is configured to heat a heating target using the refrigerant flowing out of one outflow port of the branch portion as a heat source. The low temperature decompression unit is configured to decompress the refrigerant flowing out of the heating unit. The bypass passage is configured to allow another portion of the refrigerant branched at the branch portion to flow through the bypass passage. The bypass decompression unit is configured to adjust a flow rate of the refrigerant flowing through the bypass passage. The merging portion is configured to merge a flow of the refrigerant flowing out of the bypass decompression unit and a flow of the refrigerant flowing out of the low temperature decompression unit to flow out toward a suction port of the compressor. The heat absorption unit is configured to cause at least the refrigerant flowing out of the low temperature decompression unit to absorb heat of a heat absorption target.

The control unit is configured to execute control switching between a first heating mode and a second heating mode. The first heating mode is configured to cause all of the refrigerant discharged from the compressor to flow into the heating unit via the branch portion, and pump up heat absorbed from the heat absorption target in the heat absorption unit to heat the heating target. The second heating mode is configured to cause a part of the refrigerant discharged from the compressor to flow into the bypass passage via the branch portion, and guide the refrigerant flowing out of the bypass decompression unit to the merging portion. Simultaneously, the second heating mode is configured to cause another part of the refrigerant discharged from the compressor to flow into the heating unit via the branch portion, and cause the refrigerant flowing out of the heating unit to merge with a flow of the refrigerant from the bypass decompression unit at the merging portion to be sucked into the compressor.

The control unit is configured to, when switching from the first heating mode to the second heating mode, execute a heat absorption-amount securing operation of securing a heat absorption amount in the heat absorption unit using heat of the refrigerant discharged from the compressor and heat absorbed from the heat absorption target in the heat absorption unit, and complete the switching to the second heating mode after executing the heat absorption-amount securing operation.

Accordingly, in the heat pump cycle device according to the second aspect, a heat absorption-amount securing operation is performed when switching from the first heating mode to the second heating mode to ensure sufficient heat absorption by the refrigerant. This makes it possible to increase the heat content of the refrigerant immediately before switching to the second heating mode. As a result, the heat pump cycle device according to the second aspect can minimize the difference in heating capacity between the first and second heating modes, thereby suppressing fluctuations in heating capacity.

According to a third aspect of the present disclosure, a heat pump cycle device includes a heat pump cycle, a heat medium circuit, and a control unit. The heat pump cycle includes a compressor, a heat-medium refrigerant heat exchanger, a decompression unit, and a chiller. The compressor is configured to compress and discharge a refrigerant. The heat-medium refrigerant heat exchanger is configured to release heat of a high-pressure refrigerant discharged from the compressor to a heat medium. The decompression unit is configured to decompress the refrigerant flowing out of the heat-medium refrigerant heat exchanger. The chiller is configured to cause the refrigerant to absorb heat via heat exchange between the refrigerant decompressed by the decompression unit and the heat medium.

The heat medium circuit includes a first circuit, a second circuit, a heat-medium connection flow path, and a flow rate adjustment unit. The first circuit is configured to allow the heat medium flowing out of the heat-medium refrigerant heat exchanger to circulate through the first circuit, and includes a heat medium radiator configured to release heat of the heat medium to a heating target. The second circuit is configured to allow the heat medium flowing through the chiller to circulate through the second circuit, and includes a heat medium heat absorber configured to absorb heat from the heat absorption target via heat exchange with the heat medium. The heat-medium connection flow path is connected between the first circuit and the second circuit so that the heat medium is allowed to flow in and out. The flow rate adjustment unit is configured to adjust a flow rate of the heat medium flowing in and out between the first circuit and the second circuit via the heat-medium connection flow path.

The control unit is configured to execute control switching between an independent circulation heating mode and a circuit cooperation heating mode. The independent circulation heating mode is configured to cause the heat medium to independently circulate through the second circuit and absorb heat derived from the heat absorption target to be pumped up by the heat pump cycle, and cause the heat medium to independently circulate through the first circuit and heat the heating target in the heat medium radiator using the heat pumped up. The circuit cooperation heating mode is configured to cause a part of the heat medium flowing out of the heat-medium refrigerant heat exchanger to flow through the chiller via the heat-medium connection flow path, and cause another part of the heat medium flowing out of the heat-medium refrigerant heat exchanger to circulate through the first circuit via the heat medium radiator to heat the heating target in the heat medium radiator.

The control unit is configured to, when switching from the independent circulation heating mode to the circuit cooperation heating mode, execute a limiting operation of limiting an amount of released heat in the heat medium radiator in the independent circulation heating mode to a low level, and complete the switching to the circuit cooperation heating mode after executing the limiting operation.

Therefore, in the heat pump cycle device according to the third aspect, a limiting operation is performed when switching from the independent circulation heating mode to the circuit cooperation heating mode, reducing the amount of heat released by the heat medium radiator. This allows the heat content of the refrigerant immediately before switching to the circuit cooperation heating mode to be increased. As a result, the heat pump cycle device according to the third aspect can minimize the difference in heating capacity between the independent circulation heating mode and the circuit cooperation heating mode, thereby suppressing fluctuations in heating capacity.

Hereinafter, multiple embodiments will be described with reference to the drawings. Elements corresponding to each other among the embodiments are assigned the same numeral and their descriptions may be omitted. When only a part of an element is described in an embodiment, the other part of the element can be relied on the element of a preceding embodiment. Furthermore, in addition to the combination of elements explicitly described in each embodiment, it is also possible to combine elements from different embodiments, as long as the combination poses no difficulty, even if not explicitly described.

### First Embodiment

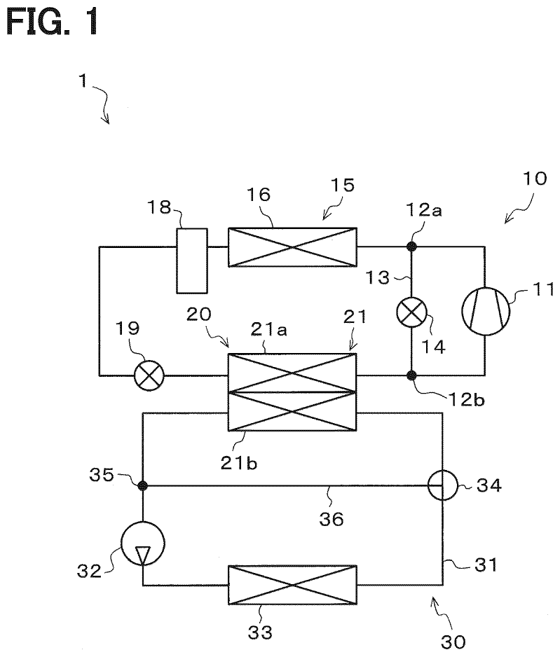

A first embodiment of a heat pump cycle device in the present disclosure will be described with reference to FIGS. 1 to 6. In the first embodiment, the heat pump cycle device according to the present disclosure is applied to a vehicle air conditioner 1 mounted on an electric vehicle. The electric vehicle is a vehicle that obtains driving force for traveling from an electric motor.

The vehicle air conditioner 1 according to the first embodiment includes a heat pump cycle 10, a heat medium circuit 30, an interior air conditioning unit 60, a control device 70, and the like, and performs air conditioning of the vehicle compartment which is a space to be air-conditioned.

Next, a schematic configuration of the vehicle air conditioner 1 according to the first embodiment will be described. First, a configuration of a heat pump cycle 10 in the vehicle air conditioner 1 according to the first embodiment will be described with reference to FIG. 1.

The heat pump cycle 10 of the vehicle air conditioner 1 according to the first embodiment is a vapor compression refrigeration cycle configured to adjust the temperature of the blown air blown into the vehicle compartment and the heat medium circulating in the heat medium circuit 30.

The heat pump cycle 10 is configured to be able to switch a refrigerant circuit according to various operation modes in order to perform air conditioning in the vehicle compartment. In the heat pump cycle 10, an HFO refrigerant (specifically, R1234yf) is used as the refrigerant. The heat pump cycle 10 constitutes a subcritical refrigeration cycle in which the pressure of the high-pressure refrigerant does not exceed the critical pressure of the refrigerant.

Refrigerating machine oil for lubricating a compressor 11 is mixed in the refrigerant. The refrigerating machine oil is PAG oil (that is, polyalkylene glycol oil) or POE (that is, polyol ester) having compatibility with a liquid-phase refrigerant. Part of the refrigerating machine oil circulates in the heat pump cycle 10 together with the refrigerant.

As illustrated in FIG. 1, the heat pump cycle 10 according to the first embodiment includes the compressor 11, a bypass passage 13, a bypass expansion valve 14, an interior condenser 16, a receiver 18, a low temperature expansion valve 19, and a chiller 21.

The compressor 11 sucks, compresses, and discharges the refrigerant in heat pump cycle 10. The compressor 11 is an electric compressor in which a fixed capacity type compression mechanism having a fixed discharge capacity is rotationally driven by an electric motor. Refrigerant discharge performance (that is, the rotation speed) of the compressor 11 is controlled by a control signal output from the control device 70.

The compressor 11 is disposed in a drive device room formed at the front of the vehicle compartment. The drive device room forms a space in which at least part of equipment (for example, a motor generator serving as an electric motor for traveling) or the like used for generating or adjusting a driving force for traveling of the vehicle is disposed.

An inflow port of a branch portion 12a formed in a three-way joint shape is connected to a discharge port of the compressor 11. The branch portion 12a has three inflow/outflow ports communicating with each other. As the branch portion 12a, a joint portion formed by joining a plurality of pipes or a joint portion formed by providing a plurality of refrigerant passages in a metal block or a resin block can be used.

The heat pump cycle 10 according to the first embodiment includes a merging portion 12b formed in a three-way joint shape. The basic configuration of the merging portion 12b includes three inflow/outflow ports communicating with each other as in the branch portion 12a.

That is, when one of the three inflow/outflow ports in the three-way joint is used as the inflow port and the remaining two are used as the outflow ports, the three-way joint functions as a branch portion configured to branch the flow of the refrigerant. When two of the three inflow/outflow ports are used as the inflow ports and the remaining one is used as the outflow port, the three-way joint functions as a merging portion configured to merge the flows of the refrigerant. The branch portion 12a is a branch portion configured to branch the flow of the discharged refrigerant discharged from the compressor 11.

An inlet of the interior condenser 16 constituting a heating unit 15 is connected to one outflow port of the branch portion 12a. The other outflow port of the branch portion 12a is connected to one inflow port of the merging portion 12b formed in a three-way joint shape via the bypass passage 13.

The bypass passage 13 is a refrigerant passage configured to guide the flow of the refrigerant flowing out from the other outflow port of the branch portion 12a, of the high-pressure refrigerant discharged from the compressor 11, to the one inflow port of the merging portion 12b. As illustrated in FIG. 1, the bypass expansion valve 14 is disposed in the bypass passage 13.

The bypass expansion valve 14 is a decompression unit in the bypass passage 13 configured to decompress the high-pressure refrigerant (that is, the other discharge refrigerant branched at the branch portion 12a) flowing out from the other outflow port of the branch portion 12a in, for example, the hot gas heating mode among the various operation modes. The bypass expansion valve 14 can also be referred to as a bypass flow rate adjustment unit configured to adjust the flow rate (mass flow rate) of the refrigerant flowing through the bypass passage 13.

The bypass expansion valve 14 is an electric variable throttle mechanism including a valve body configured to change a throttle opening and an electric actuator (specifically, the stepping motor) as a drive unit configured to displace the valve body. The operation of the bypass expansion valve 14 is controlled by a control pulse output from the control device 70.

The bypass expansion valve 14 has a fully open function configured to function as a simple refrigerant passage without exhibiting a refrigerant decompression function and a flow rate adjustment function by setting the throttle opening to a full-open state. Further, the bypass expansion valve 14 has a fully closed function of closing the refrigerant passage by setting the throttle opening to a fully closed state.

As described above, the interior condenser 16 is connected to one outflow port of the branch portion 12a. The interior condenser 16 is a heat radiating heat exchange unit configured to exchange heat between the high-pressure refrigerant discharged from the compressor 11 and the blown air supplied into the vehicle compartment to release heat of the high-pressure refrigerant to the blown air. The interior condenser 16 constitutes the heating unit 15 configured to heat blown air as a heating target using the refrigerant discharged from the compressor 11 as a heat source.

The receiver 18 is connected to the outflow port of the interior condenser 16. The receiver 18 is a gas-liquid separation unit configured to separate the refrigerant flowing out of the condenser (that is, the interior condenser 16) in the heat pump cycle 10 into gas and liquid to cause the liquid-phase refrigerant to flow downstream, and stores surplus refrigerant of the cycle.

The low temperature expansion valve 19 is connected to an outflow port of the receiver 18. The low temperature expansion valve 19 is a decompression unit configured to decompress the refrigerant flowing into a refrigerant passage 21a of the chiller 21 constituting a heat absorption unit 20 when causing the refrigerant to absorb heat in the heat absorption unit 20. In other words, the low temperature expansion valve 19 is a chiller flow rate adjustment unit configured to adjust the flow rate (mass flow rate) of the refrigerant flowing into the chiller 21.

As in the bypass expansion valve 14, the low temperature expansion valve 19 is configured as an electric variable throttle mechanism including a valve body and an electric actuator. The operation of the low temperature expansion valve 19 is controlled by a control pulse output from the control device 70. As in the bypass expansion valve 14, the low temperature expansion valve 19 has a fully open function and a fully closed function.

The chiller 21 constituting the heat absorption unit 20 is connected to the outflow port of the low temperature expansion valve 19. The heat absorption unit 20 absorbs heat for the low-pressure refrigerant decompressed by the low temperature expansion valve 19, and includes the heat medium circuit 30 and the chiller 21 in the first embodiment.

The chiller 21 includes a refrigerant passage 21a through which the low-pressure refrigerant decompressed by the low temperature expansion valve 19 flows, and a heat medium passage 21b through which the heat medium circulating in the heat medium circuit 30 flows. The chiller 21 is a low temperature heat medium heat exchange unit configured to exchange heat between the low-pressure refrigerant flowing through the refrigerant passage 21a and the heat medium flowing through the heat medium passage 21b. The chiller 21 cools the heat medium by evaporating the low-pressure refrigerant to exert a heat absorbing action.

As illustrated in FIG. 1, the merging portion 12b having a three-way joint shape is connected to the outlet of the refrigerant passage 21a in the chiller 21. As described above, the bypass passage 13 and the bypass expansion valve 14 are connected to one inflow port of the merging portion 12b. The outlet of the refrigerant passage 21a of the chiller 21 is connected to the other inflow port of the merging portion 12b.

A suction port of the compressor 11 is connected to an outflow port of the merging portion 12b. Therefore, the merging portion 12b can merge the flow of the refrigerant flowing out of the refrigerant passage 21a of the chiller 21 and the flow of the refrigerant flowing through the bypass passage 13, and guide the merged flow to the suction port of the compressor 11.

Next, a heat medium circuit 30 of the vehicle air conditioner 1 according to the first embodiment will be described with reference to the drawings. The heat medium circuit 30 is a circuit configured to circulate the heat medium. In the present embodiment, an ethylene glycol aqueous solution is employed as the heat medium.

As illustrated in FIG. 1, since the heat medium circuit 30 according to the first embodiment is configured to be capable of exchanging heat with the low-pressure refrigerant in the heat pump cycle 10 by the chiller 21, it can be referred to as a low temperature circuit 31. In the low temperature circuit 31, in addition to the heat medium passage 21b of the chiller 21, a low temperature pump 32, an outside air heat exchanger 33, a heat medium three-way valve 34, and a bypass connection portion 35 are disposed.

The low temperature pump 32 is a heat medium pressure feeding unit configured to suck the heat medium flowing out of the heat medium three-way valve 34 and pressure-feeds the heat medium to the outside air heat exchanger 33. low temperature pump 32 is an electric water pump whose rotation speed (that is, pressure feeding capability) is controlled by a control voltage output from control device 70. Therefore, in the first embodiment, the circulation of the heat medium in the low temperature circuit 31 can be realized by driving the low temperature pump 32.

The outside air heat exchanger 33 is connected to a discharge port of the low temperature pump 32. The outside air heat exchanger 33 is disposed outside the vehicle compartment, and exchanges heat between the heat medium cooled by the chiller 21 and circulating through the low temperature circuit 31 and the outside air outside the vehicle compartment. The outside air heat exchanger 33 constitutes part of a heat absorption unit for causing the low-pressure refrigerant to absorb heat from the outside air via the heat medium.

The heat medium three-way valve 34 is connected to the heat medium outlet of the outside air heat exchanger 33. The heat medium three-way valve 34 is an electric three-way flow rate adjustment valve having three inflow/outflow ports, and is configured to be able to continuously adjust a passage area ratio of each outflow port. The operation of the heat medium three-way valve 34 is controlled by a control signal output from the control device 70.

As described above, the heat medium outlet of the outside air heat exchanger 33 is connected to one inflow/outflow port of the heat medium three-way valve 34, and one inflow/outflow port of the heat medium passage 21b of the chiller 21 is connected to another inflow/outflow port of the heat medium three-way valve 34. A heat medium bypass flow path 36 is connected to another inflow/outflow port of the heat medium three-way valve 34.

As illustrated in FIG. 1, the bypass connection portion 35 is connected to the other of the inflow/outflow ports of the heat medium passage 21b of the chiller 21. The bypass connection portion 35 is formed in a three-way joint shape having three inflow/outflow ports, and as described above, the other of the inflow/outflow ports in the heat medium passage 21b of the chiller 21 is connected to one inflow/outflow port in the bypass connection portion 35.

The heat medium bypass flow path 36 is connected to the other inflow/outflow port of the bypass connection portion 35, and the suction port of the low temperature pump 32 is connected to the other inflow/outflow port in the heat medium bypass flow path 36.

Therefore, according to the low temperature circuit 31 of the first embodiment, the circulation path of the heat medium via the chiller 21 and the outside air heat exchanger 33 can be switched by controlling the operations of the low temperature pump 32 and the heat medium three-way valve 34.

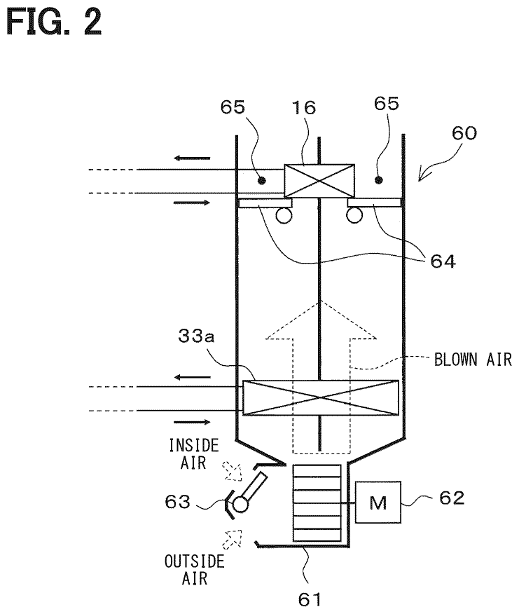

Next, a configuration of the interior air conditioning unit 60 constituting the vehicle air conditioner 1 will be described with reference to FIG. 2. The interior air conditioning unit 60 is a unit for blowing blown air whose temperature has been adjusted by the heat pump cycle 10 to an appropriate location in the vehicle compartment, in the vehicle air conditioner 1. The interior air conditioning unit 60 is disposed inside an instrument panel at the foremost part of the vehicle compartment.

The interior air conditioning unit 60 according to the first embodiment is configured so that an interior blower 62, a cooler core 33a, the interior condenser 16, and the like are accommodated in an air passage formed inside an air conditioning case 61 forming an outer shell thereof. The air conditioning case 61 forms an air passage for blown air to be blown into the vehicle compartment. The air conditioning case 61 is made of resin (specifically, polypropylene) having a certain degree of elasticity and excellent strength.

As illustrated in FIG. 2, an inside/outside air switching device 63 is disposed on the most upstream side of the air conditioning case 61 in the blown air flow direction. The inside/outside air switching device 63 switchingly introduces inside air (air inside the vehicle compartment) and outside air (air outside the vehicle compartment) into the air conditioning case 61.

The inside/outside air switching device 63 continuously adjusts the opening areas of the inside air introduction port for introducing the inside air and the outside air introduction port for introducing the outside air into the air conditioning case 61 by the inside/outside air switch door to change the introduction ratio between the introduction air volume of the inside air and the introduction air volume of the outside air. The inside/outside air switch door is driven by an electric actuator for the inside/outside air switch door. The operation of the electric actuator is controlled by a control signal output from the control device 70.

The interior blower 62 is disposed downstream of the inside/outside air switching device 63 in the blown air flow direction. The interior blower 62 includes an electric blower configured to drive a centrifugal multi-blade fan with an electric motor. The interior blower 62 blows air sucked through the inside/outside air switching device 63 toward the vehicle compartment. The rotation speed (that is, blowing capacity) of the interior blower 62 is controlled by a control voltage output from the control device 70. Since the interior blower 62 can adjust the volume of the blown air to be temperature-adjusted, it corresponds to an example of the supply adjustment unit.

In the first embodiment, the cooler core 33a and the interior condenser 16 are disposed in this order with respect to the flow of the blown air downstream of the interior blower 62 in the blown air flow direction. The cooler core 33a constitutes a cooling heat exchanger configured to exchange heat between a medium (for example, a heat medium, a refrigerant, or the like) cooled by a cold heat source (not illustrated) and blown air flowing through the air conditioning case 61 to cool the blown air.

As illustrated in FIG. 2, the cooler core 33a is disposed upstream of the interior condenser 16 in the blown air flow direction in the air conditioning case 61 of the interior air conditioning unit 60. Therefore, in the interior air conditioning unit 60 of the vehicle air conditioner 1, at least part of the blown air having passed through the cooler core 33a can be heated by the interior condenser 16.

A cold air bypass passage 65 is formed in the air conditioning case 61. The cold air bypass passage 65 is an air passage through which the blown air having passed through the cooler core 33a flows downstream while bypassing the interior condenser 16.

An air mix door 64 is disposed downstream of the cooler core 33a in the blown air flow direction and upstream of the interior condenser 16 in the blown air flow direction. The air mix door 64 adjusts an air volume ratio between an air volume passing through the interior condenser 16 and an air volume passing through the cold air bypass passage 65 in the blown air after passing through the cooler core 33a.

The air mix door 64 is driven by an electric actuator for driving the air mix door. The operation of the electric actuator is controlled by a control signal output from the control device 70. The air mix door 64 corresponds to an example of the supply adjustment unit since it adjusts the supply amount of the blown air to be temperature-adjusted in the interior condenser 16 and the like by its operation control.

A mixing space is provided downstream of the interior condenser 16 in the blown air flow direction. In the mixing space, the blown air heated by the interior condenser 16 and the blown air passing through the cold air bypass passage 65 and not heated by the interior condenser 16 are mixed.

Further, an opening hole through which the blown air (conditioned air) mixed in the mixing space is blown into the vehicle compartment is disposed in most downstream portion of the air conditioning case 61 in the blown air flow direction. As the opening holes, a face opening hole, a foot opening hole, and a defroster opening hole (none of them illustrated) are provided.

The face opening hole is an opening hole for blowing air-conditioned air toward the upper body of the occupant in the vehicle compartment. The foot opening hole is an opening hole for blowing air-conditioned air toward the feet of the occupant. The defroster opening hole is an opening hole for blowing air-conditioned air toward the inner face of the windshield.

The face opening hole, the foot opening hole, and the defroster opening hole are connected to a face blow-out port, a foot blow-out port, and a defroster blow-out port (none of them illustrated) provided in the vehicle compartment via ducts forming air passages, respectively.

Therefore, the temperature of the air-conditioned air mixed in the mixing space is adjusted by the air mix door 64 adjusting the air volume ratio between the air volume passing through the interior condenser 16 and the air volume passing through the cold air bypass passage 65. As a result, the temperature of the blown air (air-conditioned air) blown into the vehicle compartment from each of the blow-out ports is also adjusted.

A face door, a foot door, and a defroster door (none of them illustrated) are disposed upstream of the face opening hole, the foot opening hole, and the defroster opening hole in the blown air flow direction, respectively. The face door adjusts an opening area of the face opening hole. The foot door adjusts an opening area of the foot opening hole. The defroster door adjusts an opening area of the defroster opening hole.

The face door, the foot door, and the defroster door constitute a blow-out mode switch device configured to switch a blow-out port through which air-conditioned air is blown. The face door, the foot door, and the defroster door are connected to an electric actuator for driving the blow-out port mode door via a link mechanism or the like and rotated in conjunction therewith. The operation of the electric actuator is controlled by a control signal output from the control device 70.

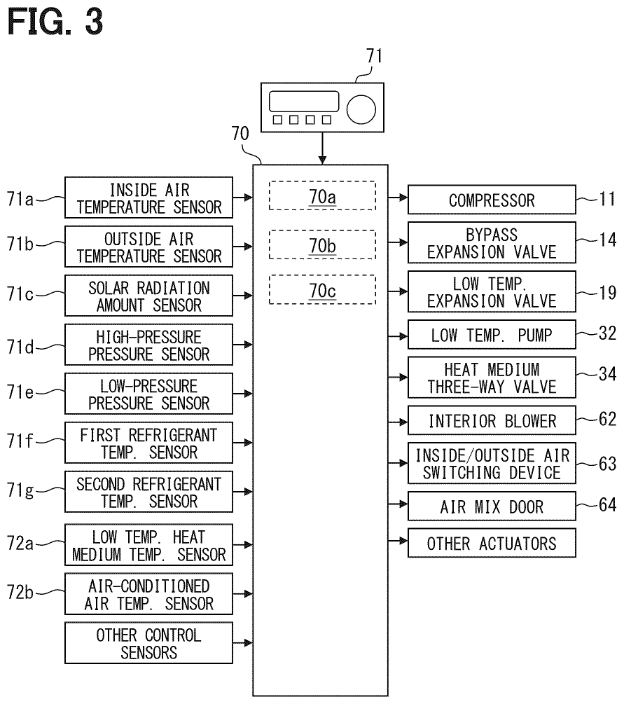

Next, an outline of a control system of the vehicle air conditioner 1 will be described with reference to FIG. 3. The control device 70 includes a known microcomputer including a CPU, a ROM, a RAM, and the like, and the peripheral circuit thereof. The control device 70 performs various calculations and processes based on an air conditioning control program stored in the ROM, and controls operations of various control target devices connected to the output thereof. The control device 70 corresponds to an example of the control unit.

In the first embodiment, the various control target devices include the compressor 11, the bypass expansion valve 14, the low temperature expansion valve 19, the low temperature pump 32, the heat medium three-way valve 34, the interior blower 62, the inside/outside air switching device 63, the air mix door 64, and the like.

As illustrated in FIG. 3, various control sensors are connected to the input of the control device 70. The control sensors include an inside air temperature sensor 72a, an outside air temperature sensor 72b, and a solar radiation amount sensor 72c. The control sensors include a high-pressure pressure sensor 72d, a low-pressure pressure sensor 72e, a first refrigerant temperature sensor 72f, and a second refrigerant temperature sensor 72g. Further, the control sensors include a low temperature heat medium temperature sensor 73a and an air-conditioned air temperature sensor 73b.

The inside air temperature sensor 72a is an inside air temperature detection unit configured to detect an inside air temperature Tr which is a temperature in the vehicle compartment. The outside air temperature sensor 72b is an outside air temperature detection unit configured to detect an outside air temperature Tam that is a temperature outside the vehicle compartment. The solar radiation amount sensor 72c is a solar radiation amount detection unit configured to detect a solar radiation amount As with which the vehicle compartment is irradiated.

The high-pressure pressure sensor 72d is a high-pressure pressure detection unit configured to detect a high pressure Pd that is the pressure of the high-pressure refrigerant discharged from the compressor 11. The low-pressure pressure sensor 72e is a low-pressure pressure detection unit configured to detect a suction pressure (low pressure Ps) of the suction refrigerant sucked into the compressor 11. The first refrigerant temperature sensor 72f is a high-pressure temperature detection unit configured to detect the temperature of the high-pressure refrigerant in the heat pump cycle 10. The first refrigerant temperature sensor 72f is disposed, for example, at the outflow port of the interior condenser 16. The second refrigerant temperature sensor 72g is a low-pressure temperature detection unit configured to detect the temperature of the low-pressure refrigerant in the heat pump cycle 10. The second refrigerant temperature sensor 72g is disposed, for example, at the outlet of the refrigerant passage 21a in the chiller 21.

The low temperature heat medium temperature sensor 73a is a temperature detection unit configured to detect the temperature of the heat medium circulating in the low temperature circuit 31 in the heat medium circuit 30. The low temperature heat medium temperature sensor 73a is disposed, for example, at the outlet of the heat medium passage 21b of the chiller 21. The air-conditioned air temperature sensor 73b is an air-conditioned air temperature detection unit configured to detect a temperature TAV of the blown air blown into the vehicle compartment from the mixing space.

Further, an operation panel 71 disposed in the vicinity of the instrument panel in the front portion of the vehicle compartment is connected to the input of the control device 70. Operation signals from various operation switches provided on the operation panel 71 are input to the control device 70.

Specific examples of the various operation switches provided on the operation panel 71 include an automatic switch, an air conditioner switch, an air volume setting switch, and a temperature setting switch. The automatic switch is an operation switch configured to set or cancel the automatic control operation of the heat pump cycle 10.

The air conditioner switch is an operation switch configured to request the cooler core 33a to cool the blown air. The air volume setting switch is an operation switch operated when the air volume of the interior blower 62 is manually set. The temperature setting switch is an operation switch for setting a target temperature Tset in the vehicle compartment.

In the control device 70 of the present embodiment, a control unit configured to control various control target devices connected to an output thereof is integrally configured. Therefore, a configuration (that is, hardware and software) that controls the operation of each device to be controlled constitutes a control unit configured to control the operation of each device to be controlled.

For example, in control device 70, a configuration for executing switching control for reducing a difference in heating capacity of a heating target (that is, the blown air) at the time of switching from a heat pump heating mode to a hot gas heating mode to be described later corresponds to switching control execution unit 70a.

In the control device 70, a configuration for performing control related to a limiting operation of limiting an amount of released heat in the heating unit 15 in the switching control when the heat pump heating mode is switched to the hot gas heating mode corresponds to a limitation control unit 70b.

In the control device 70, a configuration for performing a heat absorption-amount securing operation of securing a heat absorption amount in the heat absorption unit 20 in the switching control when the heat pump heating mode is switched to the hot gas heating mode corresponds to a heat absorption amount securing control unit 70c.

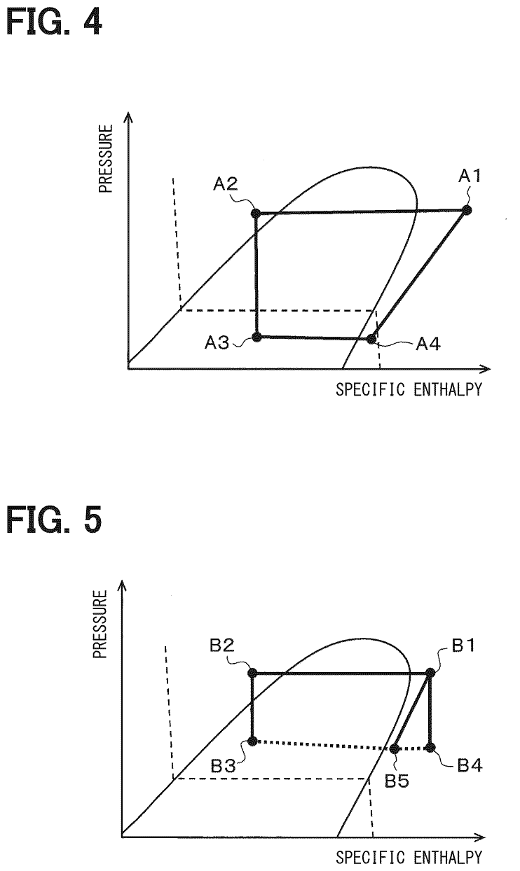

The operation mode in the vehicle air conditioner 1 for heating blown air as a heating target includes a heat pump heating mode and a hot gas heating mode. First, the heat pump heating mode in the vehicle air conditioner 1 will be described with reference to FIG. 4.

The heat pump heating mode according to the first embodiment is an operation mode for heating blown air by drawing heat absorbed from a heat absorption source (air outside the vehicle compartment) via the low temperature circuit 31 and radiating heat to the blown air at the interior condenser 16 constituting the heating unit 15. Accordingly, the heat pump heating mode corresponds to an example of the first heating mode because the heat pump heating mode heats blown air by pumping up heat absorbed from the heat absorption source.

In the heat pump heating mode according to the first embodiment, the control device 70 brings the bypass expansion valve 14 into the fully closed state and brings the low temperature expansion valve 19 into the throttling state. Therefore, in the heat pump cycle 10 in the heat pump heating mode, the circuit is switched to a refrigerant circuit in which the refrigerant flows and circulates through the compressor 11, the branch portion 12a, the interior condenser 16, the receiver 18, the low temperature expansion valve 19, the chiller 21, the merging portion 12b, and the compressor 11 in this order.

The control device 70 controls the refrigerant discharge performance of the compressor 11 so that the high pressure Pd detected by the high-pressure pressure sensor 72d approaches the target high pressure PDO. The target high pressure PDO is determined based on the target blowing temperature TAO with reference to a control map stored in advance in the control device 70. In the control map, it is determined to increase the target high pressure PDO as the target blowing temperature TAO increases.

The control device 70 controls the throttle opening of the low temperature expansion valve 19 so that the degree of superheating SHC of the refrigerant at the outlet of the refrigerant passage 21a in the chiller 21 approaches the reference degree of superheating KSH within a range in which the refrigerant evaporating temperature in the chiller 21 is lower than the outside air temperature Tam.

Regarding the heat medium circuit 30, the control device 70 determines the pressure feeding capability of the low temperature pump 32 and the opening area ratio of the three outflow/inflow ports of the heat medium three-way valve 34 so as to be able to secure the heat absorption amount necessary for achieving the target blowing temperature.

With respect to the interior air conditioning unit 60, the control device 70 determines and controls the blowing capacity of the interior blower 62, the inside/outside air ratio in the inside/outside air switching device 63, and the ratio of the air mix door 64 according to the operating condition determined for the heat pump heating mode.

Therefore, in the heat pump cycle 10 in the heat pump heating mode, the state of the refrigerant changes as illustrated in the Mollier diagram of FIG. 4. That is, the discharged refrigerant discharged from the compressor 11 (point A1 in FIG. 4) flows into the interior condenser 16 via the branch portion 12a. The refrigerant having flowed into the interior condenser 16 releases heat to blown air as a heating target and condenses in the interior air conditioning unit 60 (from point A1 to point A2 in FIG. 4). As a result, the blown air as the heating target is heated, and heating of the vehicle compartment is realized.

The refrigerant flowing out of the interior condenser 16 flows into the receiver 18 and is separated into gas and liquid. The liquid-phase refrigerant flowing out of the receiver 18 flows into the low temperature expansion valve 19 and is decompressed (from point A2 to point A3 in FIG. 4). The refrigerant decompressed by the low temperature expansion valve 19 flows into the chiller 21 constituting the heat absorption unit 20. The refrigerant flowing into the refrigerant passage 21a of the chiller 21 absorbs heat from the heat medium flowing through the heat medium passage 21b and evaporates (from point A3 to point A4 in FIG. 4). The refrigerant flowing out of the refrigerant passage 21a of the chiller 21 is sucked into the compressor 11 and compressed again (from point A4 to point A1 in FIG. 4).

That is, in the heat pump cycle 10 in the heat pump heating mode, a vapor compression refrigeration cycle is configured in which the interior condenser 16 functions as a condenser and the chiller 21 functions as an evaporator.

Next, the hot gas heating mode in the vehicle air conditioner 1 will be described with reference to FIG. 5. In the hot gas heating mode according to the first embodiment, part of the high-pressure refrigerant discharged from the compressor 11 is introduced to the low-pressure flow path via the bypass passage 13, thereby improving the heating capacity of the heating target using the amount of work done by the compressor 11. The hot gas heating mode corresponds to an example of the second heating mode.

In the hot gas heating mode, since the heating target is heated using the amount of work done by the compressor 11 without using the heat absorption source (that is, the low temperature circuit 31 and the outside air), even in a case where the heat absorption amount from the heat absorption source cannot be secured, the heating capacity can be improved.

In the heat pump cycle 10 in the hot gas heating mode according to the first embodiment, the control device 70 brings the bypass expansion valve 14 into the throttling state and brings the low temperature expansion valve 19 into the throttling state. Therefore, in the hot gas heating mode, part of the refrigerant discharged from the compressor 11 flows and circulates through the compressor 11, the branch portion 12a, the interior condenser 16, the receiver 18, the low temperature expansion valve 19, the chiller 21, the merging portion 12b, and the compressor 11 in this order. At the same time, the other part of the refrigerant discharged from the compressor 11 flows and circulates through the compressor 11, the branch portion 12a, the bypass passage 13, the bypass expansion valve 14, the merging portion 12b, and the compressor 11 in this order. That is, in the hot gas heating mode, the circuit is switched to a refrigerant circuit in which a path through which the refrigerant circulates via the interior condenser 16 and a path through which the refrigerant circulates via the bypass passage 13 coexist.

The control device 70 controls the refrigerant discharge performance of the compressor 11 so that the chiller refrigerant pressure Pc approaches a predetermined target low-pressure. Controlling the chiller refrigerant pressure Pc corresponding to the suction refrigerant pressure (low pressure Ps) so as to approach a constant pressure is effective for stabilizing the discharge flow rate Gr (mass flow rate) of the compressor 11.

More specifically, by setting the low pressure Ps to a saturated gas-phase refrigerant having a constant pressure, the density of the suction refrigerant is constant. Therefore, when the low pressure Ps is controlled to approach a constant pressure, it is easy to stabilize the discharge flow rate Gr of the compressor 11 at the same rotation speed.

The control device 70 controls the throttle opening of the bypass expansion valve 14 so that the discharge refrigerant pressure (the high pressure Pd) approaches the target high pressure PDO. The control device 70 controls the throttle opening of the low temperature expansion valve 19 so that the degree of superheating SH of the suction refrigerant approaches the reference degree of superheating KSH.

In the heat medium circuit 30 in the hot gas heating mode, the control device 70 stops the low temperature pump 32. In the interior air conditioning unit 60 in the hot gas heating mode, the control device 70 controls the operations of the interior blower 62, the inside/outside air switching device 63, and the air mix door 64. In the hot gas heating mode, the opening of the air mix door 64 is often controlled so that almost the entire volume of blown air blown from the interior blower 62 passes through the interior condenser 16.

Therefore, in the heat pump cycle 10 in the hot gas heating mode according to the first embodiment, the state of the refrigerant changes as illustrated in the Mollier diagram in FIG. 5.

First, a flow of a discharged refrigerant (point B1 in FIG. 5) discharged from compressor 11 is branched at branch portion 12a. The refrigerant of one flow branched at the branch portion 12a flows into the interior condenser 16 constituting the heating unit 15, and releases heat to the blown air in the interior air conditioning unit 60 (from point B1 to point B2 in FIG. 5). As a result, the blown air as the heating target is heated, and the vehicle compartment can be heated.

The refrigerant flowing out of the interior condenser 16 flows into the low temperature expansion valve 19 via the receiver 18 and is decompressed (from point B2 to point B3 in FIG. 5). The refrigerant decompressed by the low temperature expansion valve 19 flows into the chiller 21 constituting the heat absorption unit 20. In the hot gas heating mode, since the low temperature pump 32 is stopped, the chiller 21 does not exchange heat between the refrigerant and the heat medium of the low temperature circuit 31. The refrigerant flowing out of the chiller 21 flows into another inflow port of the merging portion 12b.

Another refrigerant branched at the branch portion 12a flows into the bypass passage 13. The refrigerant flowing into the bypass passage 13 is decompressed by the bypass expansion valve 14 (from point B1 to point B5 in FIG. 5). The refrigerant decompressed by the bypass expansion valve 14 flows into one inflow port of the merging portion 12b. The refrigerant flowing out of the chiller 21 and the refrigerant flowing out of the bypass expansion valve 14 are merged and mixed at the merging portion 12b having a three-way joint shape (point B5 in FIG. 5), and sucked into the compressor 11.

In the heat pump cycle 10 in the hot gas heating mode, the refrigerant having low enthalpy flowing out of the chiller 21 (point B3 in FIG. 5) and the refrigerant having high enthalpy flowing out of the bypass passage 13 (point B4 in FIG. 5) are mixed at the merging portion 12b. That is, in the heat pump cycle 10 in the hot gas heating mode, the refrigerants having different enthalpies are mixed and sucked into the compressor 11.

The hot gas heating mode is an operation mode executed in a case where the heat absorption amount in the heat absorption unit 20 is low, such as in a case where the outside air temperature Tam is extremely low. Therefore, when the refrigerant flowing out of the interior condenser 16 flows through the heat absorption unit 20, heat of the refrigerant may be released to the outside. When the heat of the refrigerant is released to the outside, the amount of released heat released from the refrigerant to the blown air in the interior condenser 16 decreases, and the heating capacity of the blown air decreases.

On the other hand, in the hot gas heating mode of the present embodiment, since the circulation of the heat medium as a heat exchange target of the refrigerant flowing out of the bypass passage 13 is stopped, the heat of the refrigerant discharged from the compressor 11 can be maintained as much as possible.

In the hot gas heating mode, the throttle opening of the low temperature expansion valve 19 is controlled so that the degree of superheating SH of the suction refrigerant approaches the reference degree of superheating KSH. Accordingly, by increasing the refrigerant discharge performance of the compressor 11, even when the amount of released heat released from the discharged refrigerant to the blown air at the interior condenser 16 is increased, the state of the suction refrigerant (point B5 in FIG. 5) can be changed to a gas-phase refrigerant having a degree of superheating.

Therefore, in the hot gas heating mode, even when the heat absorption amount from the heat absorption source is small, the heat generated by the work done by the compressor 11 can be effectively used to heat the blown air, and the vehicle compartment can be heated.

In the heat pump heating mode of the vehicle air conditioner 1, as described above, the heat absorbed by the heat absorption unit 20 is pumped up and used for heating the heating target (blown air) in the heating unit 15. Therefore, the heating capacity in the heat pump heating mode has a strong correlation with the heat absorption amount in the heat absorption unit 20, and the heating capacity increases as the heat absorption amount increases.

The heat absorption amount in the heat absorption unit 20 is affected by the temperature of the heat absorption target and the temperature or pressure of the low-pressure refrigerant in the heat pump cycle 10. That is, in order to sufficiently secure the heat absorption amount in the heat absorption unit 20, it is necessary to adjust the temperature of the low-pressure refrigerant in the heat pump cycle 10 to be lower than that of the heat absorption target (for example, a heat medium or air) in the heat absorption unit 20.

Since the heating capacity in the heat pump heating mode is strongly affected by the heat absorption amount in the heat absorption unit 20, the required heating capacity may not be exhibited as the heating capacity of the heating target depending on the state of the heat absorption unit 20. For example, in a case where heat absorption unit 20 is configured to absorb heat from air, when the temperature of the air is too low, a sufficient heat absorption amount cannot be secured, and the heating capacity in the heat pump heating mode may be insufficient.

In this regard, in the hot gas heating mode, since the heating capacity is determined by the amount of work done by the compressor 11, the heating capacity of the heating target can be increased without being affected by the heat absorption amount in the heat absorption unit 20. The amount of work done by the compressor 11 is proportional to the flow rate of the refrigerant flowing through the compressor 11, and the flow rate of the refrigerant flowing through the compressor 11 is proportional to the density (suction density) of the refrigerant sucked into the compressor 11.

Therefore, in order to increase the heating capacity of the heating target in the hot gas heating mode, it is necessary to increase the suction density of the refrigerant in the compressor 11, in other words, it is necessary to increase the suction pressure of the refrigerant in the compressor 11.

As described above, with respect to the heating capacity of the heating target in the heat pump heating mode, the lower the pressure of the low-pressure refrigerant in the heat pump cycle 10, the higher the heating capacity can be secured. On the other hand, with respect to the heating capacity of the heating target in the hot gas heating mode, the higher the pressure of the low-pressure refrigerant in the heat pump cycle 10, the higher the heating capacity can be secured.

That is, between the heat pump heating mode and the hot gas heating mode, the heating capacity of the heating target and the pressure of the low-pressure refrigerant in the heat pump cycle 10 have contradictory characteristics.

For this reason, at the time of switching from the heat pump heating mode to the hot gas heating mode, the heating capacity may fluctuate due to contradictory characteristics of the relationship between the heating capacity of the heating target and the pressure of the low-pressure refrigerant in the heat pump cycle 10.

Specifically, when the heat pump heating mode is switched to the hot gas heating mode, the pressure of the low-pressure refrigerant in the heat pump cycle 10 is considered to be low in the heat pump heating mode in order to further exert the heating capacity.

In a case where the mode is switched to the hot gas heating mode in a state where the pressure of the low-pressure refrigerant in the heat pump cycle 10 is low, the amount of work done by the compressor 11 decreases because the suction density of the refrigerant in the compressor 11 is low. That is, when the mode is switched to the hot gas heating mode in a state where the pressure of the low-pressure refrigerant is low, it is not possible to secure heating capacity required in the hot gas heating mode, and it is not possible to secure heating capacity equivalent to that in the heat pump heating mode before switching. For this reason, since the heating capacity of the blown air decreases, it is assumed that the blowing temperature of the air-conditioned air supplied into the vehicle compartment decreases and the comfort of the occupant in the vehicle compartment decreases.

Thereafter, when the mode is switched to the hot gas heating mode, the pressure of the low-pressure refrigerant in the heat pump cycle 10 is increased in order to secure necessary heating capacity. By increasing the pressure of the low-pressure refrigerant in the heat pump cycle 10, the heating capacity of the heating target can be increased, and the blowing temperature of the air-conditioned air can be increased to the state before switching.

However, from the time point of switching from the heat pump heating mode to the hot gas heating mode to the time point when the heating capacity in the hot gas heating mode is increased to the state before switching, it takes time to increase the pressure of the low-pressure refrigerant in the heat pump cycle 10. As a result, with the switching of the operation mode, the blown air temperature of the air-conditioned air supplied into the vehicle compartment changes, and a period in which the comfort of the occupant is deteriorated occurs.

The vehicle air conditioner 1 according to the first embodiment performs switching control for suppressing fluctuation in heating capacity of a heating target due to a difference in operation mode at the time of switching from the heat pump heating mode to the hot gas heating mode.

As described above, the heating capacity in the heat pump heating mode and the hot gas heating mode is affected by the pressure of the low-pressure refrigerant in the heat pump cycle 10. In order to suppress the fluctuation of the heating capacity at the time of mode switching and to achieve the fluctuation for a shorter period of time, it is desirable to quickly realize a state where the pressure of the low-pressure refrigerant required in the hot gas heating mode is high from a state where the pressure of the low-pressure refrigerant required in the heat pump heating mode is low.

In order to increase the pressure of the low-pressure refrigerant in the heat pump cycle 10, it is necessary to increase the amount of heat of the refrigerant. Therefore, as one of the operations in the switching control for increasing the pressure of the low-pressure refrigerant in the heat pump cycle 10 to suppress the fluctuation of the heating capacity, an operation of suppressing the amount of released heat of the high-pressure part of the heat pump cycle 10 is considered.

As a result, the amount of released heat of the high-pressure part of the heat pump cycle 10 is suppressed, so that the cycle is in a state where the heat that the refrigerant discharged from the compressor 11 has is secured. Therefore, the pressure of the low-pressure refrigerant in the heat pump cycle 10 can be increased. As a result, the pressure of the low-pressure refrigerant in the heat pump cycle 10 can be quickly raised to a desired state, and the fluctuation in heating capacity due to the switching of the operation mode can be quickly eliminated. Hereinafter, at the time of the switching control of the operation mode, the operation of suppressing the amount of released heat of the high-pressure part in the heat pump cycle 10 is referred to as a limiting operation.

As one of the operations in the switching control for increasing the pressure of the low-pressure refrigerant in the heat pump cycle 10 to suppress the fluctuation of the heating capacity, an operation of maintaining the heat absorption amount of the low-pressure part of the heat pump cycle 10 as much as possible is considered.

As described above, in the heat pump heating mode before switching, heat is absorbed through the heat medium of the heat medium circuit 30 in the low-pressure heat absorption unit 20 of the heat pump cycle 10. The amount of heat absorbed by the heat absorption unit 20 constitutes the amount of heat of the refrigerant flowing through the low-pressure flow path. In this state, for example, when the low temperature pump 32 is stopped and the heat absorption in the heat absorption unit 20 is stopped, the amount of heat supplied from the heat absorption unit 20 into the low-pressure refrigerant is immediately eliminated, so that it is assumed that the pressure of the low-pressure refrigerant in the heat pump cycle 10 temporarily decreases.

In consideration of this point, the heat absorption unit 20 continues to absorb heat from the heat pump heating mode when switching from the heat pump heating mode to the hot gas heating mode. However, the switching control at the time of switching the operation mode is performed within a range in which the heat absorption amount in the heat absorption unit 20 can be maintained, and a decrease in the pressure of the low-pressure refrigerant in the heat pump cycle 10 is suppressed. Hereinafter, an operation of maintaining the heat absorption amount of the low-pressure part of the heat pump cycle 10 as much as possible at the time of switching control of the operation mode is referred to as a heat absorption-amount securing operation.

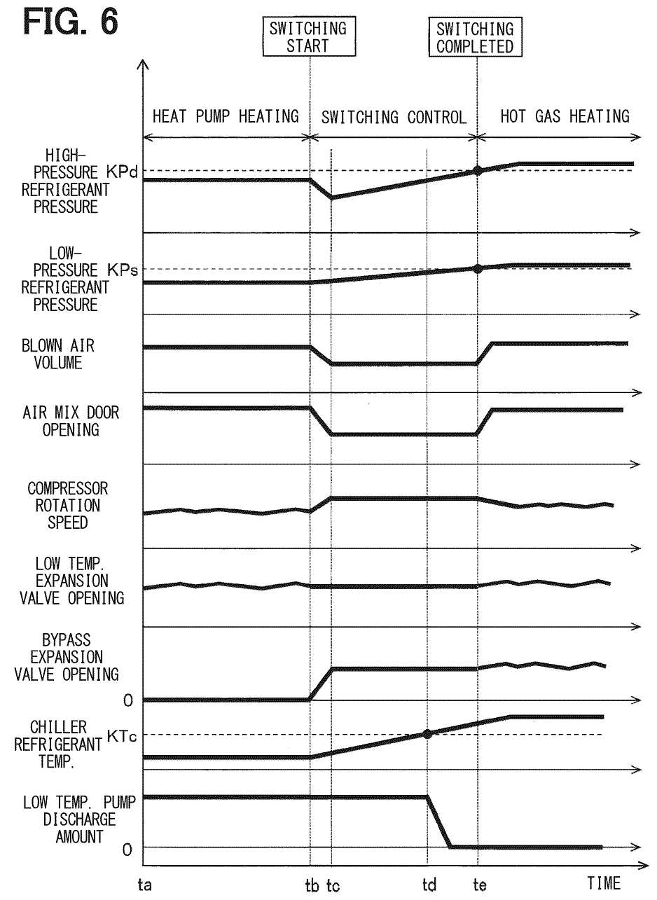

Next, switching control at the time of switching from the heat pump heating mode to the hot gas heating mode in the vehicle air conditioner 1 according to the first embodiment, including the operation of each component, will be described in detail with reference to FIG. 6.

In the example illustrated in FIG. 6, the vehicle air conditioner 1 is operating in the heat pump heating mode after time ta. As described above, in the vehicle air conditioner 1 in the heat pump heating, the control device 70 controls operations of the compressor 11, the bypass expansion valve 14, the low temperature expansion valve 19, the low temperature pump 32, the interior blower 62, the air mix door 64, and the like.

As described above, in the heat pump heating mode, the throttle opening of bypass expansion valve 14 is controlled to be in a fully closed state. The rotation speed of the compressor 11, the throttle opening of the low temperature expansion valve 19, the pressure feeding capability of the low temperature pump 32, the blowing capacity of the interior blower 62, and the opening of the air mix door 64 are controlled to satisfy the conditions determined for the heat pump heating mode described above.

At time tb, switching of the operation mode from the heat pump heating mode to the hot gas heating mode is determined, and switching control of the vehicle air conditioner 1 is started. An example of the start condition of the switching control includes a case where the heat absorption amount from the heat absorption unit 20 is insufficient for the required heating capacity, and the heat pump heating mode cannot cope with the required heating capacity. The relationship between the required heating capacity and the heat absorption amount is determined based on the relationship between the target blowing temperature as the air-conditioned air and the temperature of the heat absorption target (air) in the heat absorption unit 20.

The start condition of the switching control is not limited to the above-described example. For example, switching from the heat pump heating mode to the hot gas heating mode may be determined based on an operation by an occupant on the operation panel 71.

When the switching control from the heat pump heating mode to the hot gas heating mode is started at time tb, the operation aspects of the rotation speed of the compressor 11, the throttle opening of the low temperature expansion valve 19, the pressure feeding capability of the low temperature pump 32, the blowing capacity of the interior blower 62, and the opening of the air mix door 64 are controlled.

The rotation speed of the compressor 11 is adjusted from the rotation speed in the heat pump heating mode to a predetermined rotation speed determined in the switching control. The throttle opening of the low temperature expansion valve 19 is switched from an aspect in which the throttle opening in the heat pump heating mode fluctuates to an aspect in which a predetermined throttle opening determined in the switching control is maintained.

The throttle opening of bypass expansion valve 14 is controlled to maintain a predetermined throttle opening determined in the switching control from the fully closed state (that is, the throttle opening=0) of the heat pump heating mode.

As a result, in the heat pump cycle 10 at the time of the switching control, part of the refrigerant flows and circulates through the compressor 11, the branch portion 12a, the interior condenser 16, the receiver 18, the low temperature expansion valve 19, the chiller 21, and the merging portion 12b in this order. At the same time, the other part of the refrigerant discharged from the compressor 11 flows and circulates through the compressor 11, the branch portion 12a, the bypass passage 13, the bypass expansion valve 14, the merging portion 12b, and the compressor 11 in this order.

That is, in the switching control, the circuit is switched to a refrigerant circuit in which a path through which the refrigerant circulates via the interior condenser 16 and a path through which the refrigerant circulates via the bypass passage 13 coexist. At this time, in the heat pump cycle 10 in the switching control, the interior condenser 16 functions as a radiator, and the chiller 21 functions as a heat absorber.

The pressure feed amount (that is, the discharge amount of the heat medium) of the low temperature pump 32 is controlled to maintain the pressure feed amount in the heat pump heating mode at the time of the switching control. Accordingly, in the switching control, a heat absorption amount for the low-pressure refrigerant in heat pump cycle 10 is maintained to be substantially equal to that in the heat pump heating mode. In the switching control, the operation of maintaining the pressure feed amount of the low temperature pump 32 corresponds to an example of the heat absorption-amount securing operation in the switching control.

The blown air volume of the interior blower 62 is controlled to be a predetermined blown air volume with respect to the switching control, and operates so that the blown air volume maintains a predetermined value at the time of the switching control. Since the blown air volume of the interior blower 62 in the switching control is set to be lower than the blown air volume in the heat pump heating mode, the blown air volume of the interior blower 62 is controlled to gradually decrease toward a predetermined value at the time of the switching control after passing time tb.

That is, in the switching control, the supply amount of the heating target (blown air) supplied to the interior condenser 16 constituting the heating unit 15 is limited by the operation control of the interior blower 62. Therefore, in the switching control, the operation of limiting the blowing capacity of the interior blower 62 to be lower than that in the heat pump heating mode corresponds to an example of the limiting operation in the switching control.

The opening of the air mix door 64 is controlled to be a predetermined value set so that the opening of the cold air bypass passage 65 is larger than that in the heat pump heating mode. That is, at the time of the switching operation, the air mix door 64 is controlled so that most of the blown air having passed through the cooler core 33a flows while bypassing the interior condenser 16.

When the supply amount of the heating target (blown air) to be supplied to the interior condenser 16 is limited to be lower than that in the heat pump heating mode, the amount of released heat released from the high-pressure refrigerant in the heat pump cycle 10 in the heating unit 15 also decreases to be smaller than that in the heat pump heating mode. Therefore, in the switching control, the operation of adjusting the opening of the air mix door 64 corresponds to an example of the limiting operation in the switching control.

As described above, when the operation control of each component related to the switching control is performed after passing time tb, the pressure of the high-pressure refrigerant in the heat pump cycle 10 decreases. In FIG. 6, a completion time point of various operations in the switching control is indicated as time tc.

After time tc, while the switching control is continued, the limiting operation and the heat absorption-amount securing operation described above are continued. In the switching control, a state in which the limiting operation and the heat absorption-amount securing operation are performed in parallel is referred to as a first state of the switching control.

Since the amount of released heat released from the high-pressure refrigerant in the heat pump cycle 10 is limited by the limiting operation, the value of the pressure of the high-pressure refrigerant increases with the lapse of time from the start of the limiting operation. That is, the heating capacity of the heat pump cycle 10 can be improved by the limiting operation in the switching control.

Since the heat absorption-amount securing operation secures the heat absorption amount in the heat absorption unit 20 in the low-pressure part of the heat pump cycle 10 to be substantially equal to that in the heat pump heating, the pressure of the low-pressure refrigerant gradually increases in accordance with the lapse of time from the start of the heat absorption-amount securing operation. Similarly, the temperature (that is, the temperature of the low-pressure refrigerant flowing out of the refrigerant passage 21a of the chiller 21) of the low-pressure refrigerant flowing through the heat absorption unit 20 also increases in accordance with the elapsed time after time tc. That is, by the heat absorption-amount securing operation in the switching control, the suction refrigerant density in the compressor 11 can be gradually increased to increase the amount of work done by the compressor 11.

The rotation speed of the compressor 11, the throttle opening of the low temperature expansion valve 19, the throttle opening of the bypass expansion valve 14, and the pressure feed amount of the low temperature pump 32 are controlled so as to maintain predetermined values set for the switching control.

As the switching control, when the limiting operation and the heat absorption-amount securing operation are continuously performed after time tc, the refrigerant temperature in the refrigerant passage 21a of the chiller 21 reaches a predetermined reference chiller temperature KTc. The reference chiller temperature KTc is determined based on the temperature of the heat medium flowing through the heat medium passage 21b of the chiller 21, and indicates that the heat absorption amount in the chiller 21 is smaller than a predetermined amount. That the refrigerant temperature in the refrigerant passage 21a of the chiller 21 is equal to or higher than a predetermined reference chiller temperature KTc is an example of the heat absorption stop condition.

A time point at which the temperature of the low-pressure refrigerant in the refrigerant passage 21a of the chiller 21 reaches the reference chiller temperature KTc and satisfies the heat absorption stop condition is referred to as time td. Time td indicates a time point at which the heat absorption amount in the heat absorption unit 20 cannot be sufficiently secured. Therefore, even when the heat absorption-amount securing operation is performed, it can be said that it is difficult to raise the temperature of the low-pressure refrigerant using the heat absorption amount.

Therefore, after passing time td, the operation of the low temperature pump 32 is stopped, and the pressure feed amount of the heat medium in the low temperature pump 32 is set to 0. As a result, since the heat absorption amount in the chiller 21 constituting the heat absorption unit 20 is sufficiently small, the heat absorption-amount securing operation in the switching control is terminated.

In the example illustrated in FIG. 6, the end of the heat absorption-amount securing operation is realized by stopping the operation of the low temperature pump 32, but the present invention is not limited to this aspect. For example, in order to realize the end of the heat absorption-amount securing operation, as an example of the operation of reducing the supply amount of the heat medium to the chiller 21, the circulation path of the heat medium in the low temperature circuit 31 may be switched to a path that does not pass through the heat medium passage 21b of the chiller 21. By switching the circulation path of the heat medium as described above by the operation control of the heat medium three-way valve 34, the same effect as the stopping of the operation of the low temperature pump 32 can be exhibited.

By stopping the heat absorption-amount securing operation at the time point at which the heat absorption stop condition is satisfied in this manner, it is possible to suppress waste of energy required for the heat absorption-amount securing operation and to realize switching control with high energy efficiency.

Even in a case where the heat absorption-amount securing operation is terminated, the circulation of the refrigerant and the limiting operation in the heat pump cycle 10 in the switching control are continuously performed. This state is referred to as a second state of the switching control. Since the limiting operation is continuously performed in the second state of the switching control, the pressure of the high-pressure refrigerant, the pressure of the low-pressure refrigerant, and the low-pressure refrigerant temperature in the heat pump cycle 10 increase with time even after time td and the end of the heat absorption-amount securing operation.

As described above, the switching control is performed to suppress a fluctuation in heating capacity when the heat pump heating mode is switched to the hot gas heating mode. As one method of suppressing the fluctuation of the heating capacity, it is determined whether the pressure of the high-pressure refrigerant in the heat pump cycle 10 increases until the heating capacity in the hot gas heating mode is equal to that in the heat pump heating mode in the second state of the switching control.

Specifically, it is determined whether the pressure of the high-pressure refrigerant in the heat pump cycle 10 in the switching control is higher than the predetermined reference high pressure KPd. In a case where the pressure of the high-pressure refrigerant in the heat pump cycle 10 in the switching control is higher than the reference high pressure KPd, heating capacity equivalent to that of the heat pump heating can be exhibited in the hot gas heating mode, so that variation in heating capacity can be suppressed.

As another method of suppressing the fluctuation of the heating capacity at the time of switching to the hot gas heating mode, it is conceivable to increase the amount of work done by the compressor 11 to a state equivalent to that of the heating capacity in the hot gas heating mode in the second state of the switching control. That is, it is determined whether the pressure of the low-pressure refrigerant in the heat pump cycle 10 is higher than the reference low pressure KPs in the second state of the switching control.

The reference low pressure KPs indicates the pressure of the low-pressure refrigerant in the heat pump cycle 10, and is determined so that the amount of work done by the compressor 11 in the hot gas heating mode is equivalent to that of the heating capacity in the heat pump heating mode. In a case where the pressure of the low-pressure refrigerant in the heat pump cycle 10 in the switching control is higher than the reference low pressure KPs, the heating capacity equivalent to that of the heat pump heating can be exhibited in the hot gas heating mode, so that the fluctuation of the heating capacity can be suppressed.

As illustrated in FIG. 6, when the process shifts to the second state of the switching control after passing time td, the pressure of the high-pressure refrigerant and the pressure of the low-pressure refrigerant in the heat pump cycle 10 gradually increase. A time point when either a time point at which the pressure of the high-pressure refrigerant in the heat pump cycle 10 is equal to or higher than the reference high pressure KPd or a time point at which the pressure of the low-pressure refrigerant in the heat pump cycle 10 is equal to or higher than the reference low pressure KPs is established is defined as time te.

In the example illustrated in FIG. 6, a time point at which the pressure of the high-pressure refrigerant in the heat pump cycle 10 is equal to or higher than the reference high pressure KPd and a time point at which the pressure of the low-pressure refrigerant in the heat pump cycle 10 is equal to or higher than the reference low pressure KPs are simultaneously established. The example of FIG. 6 is merely an example, and a time point at which either of the two conditions described above is established earlier may be set as time te. Further, in view of reliably suppressing the fluctuation of the heating capacity, a time point at which both the condition of the pressure of the high-pressure refrigerant and the condition of the pressure of the low-pressure refrigerant are satisfied may be set as time te.

When the condition of the pressure of the high-pressure refrigerant or the condition of the pressure of the low-pressure refrigerant in the heat pump cycle 10 is satisfied and time te elapses, the switching control is terminated and the mode shifts to the hot gas heating mode. By terminating the limiting operation and shifting to the hot gas heating mode on condition that the condition of the pressure of the high-pressure refrigerant is satisfied, the hot gas heating mode is started in a state where the heating capacity of the heat pump cycle 10 reaches a predetermined level (that is, the level before the switching control). Accordingly, the execution of the hot gas heating mode can be started in a state where fluctuation in heating capacity of the blown air as the heating target is suppressed.

By terminating the limiting operation and shifting to the hot gas heating mode on condition that the condition of the pressure of the low-pressure refrigerant is satisfied, the hot gas heating mode is started in a state where the amount of work done by the compressor 11 reaches a predetermined level (that is, the level before the switching control). Even in this case, the execution of the hot gas heating mode can be started in a state where fluctuation in heating capacity of the blown air as the heating target is suppressed.

In the hot gas heating mode, as described above, the control device 70 controls operations of the compressor 11, the bypass expansion valve 14, the low temperature expansion valve 19, the low temperature pump 32, the interior blower 62, the air mix door 64, and the like.

Specifically, in the hot gas heating mode, the throttle openings of the bypass expansion valve 14 and the low temperature expansion valve 19 are controlled to be throttle openings determined for the hot gas heating mode. The rotation speed of the compressor 11, the blowing capacity of the interior blower 62, and the opening of the air mix door 64 are controlled to satisfy the conditions determined for the hot gas heating mode described above. In the case of shifting to the hot gas heating mode following the switching control, the pressure feed amount of the low temperature pump 32 maintains a stopped state at the time of shifting from the second state of the switching control, so that it is indicated that the pressure feed amount remains zero.

As described above, when the vehicle air conditioner 1 is switched from the heat pump heating mode to the hot gas heating mode, the hot gas heating mode can be started in a state where the heating capacity of the heat pump cycle 10 is sufficiently enhanced by performing the switching control and performing the limiting operation. This configuration achieves switching between the operation modes in a state where a difference in heating capacity due to the configuration of the refrigerant circuit between the heat pump heating mode and the hot gas heating mode refrigerant circuit is suppressed.

As illustrated in FIG. 6, as the limiting operation of the switching control, the operation of the interior blower 62 is controlled to limit the supply amount of the blown air to the interior condenser 16 constituting the heating unit 15. By limiting the blown air volume of the blown air by the interior blower 62, it is possible to limit the amount of released heat of the high-pressure part of the heat pump cycle 10 and improve the heating capacity of the high-pressure part of the heat pump cycle 10.

As a limiting operation of the switching control, the opening of the air mix door 64 is controlled to limit the supply amount of the blown air to the interior condenser 16 constituting the heating unit 15. According to the operation of the air mix door 64, the supply amount of the blown air as the heating target to the interior condenser 16 can be limited from the viewpoint of the air blowing path. Therefore, the heating capacity of the heat pump cycle 10 can be sufficiently secured before the mode shifts to the hot gas heating mode by the limiting operation related to the operation control of the air mix door 64.

As illustrated in FIG. 6, in the switching control, the limiting operation and the heat absorption-amount securing operation are performed in parallel. That is, by performing the limiting operation and the heat absorption-amount securing operation in parallel, it is possible to utilize both the viewpoint of the high-pressure heating capacity of the high-pressure part of the heat pump cycle 10 and the viewpoint of the amount of work done by the compressor 11 due to the low-pressure part of the heat pump cycle 10. Accordingly, when the heat pump heating mode is switched to the hot gas heating mode, the period during which the heating capacity of the heating target fluctuates can be further shortened, and the fluctuation can be suppressed to be a small level.

In the switching control in the first embodiment, the heat absorption-amount securing operation is performed by circulating part of the refrigerant discharged from the compressor 11 through the bypass passage 13 in parallel with the operation of absorbing heat from the heat medium into the low-pressure refrigerant by the chiller 21, as in the heat pump heating. As a result, a circuit configuration that can increase the pressure of the low-pressure refrigerant in the heat pump cycle 10 to improve the amount of work done by the compressor 11, and facilitates shifting to the hot gas heating mode can be realized.

As indicated by time td in FIG. 6, the heat absorption-amount securing operation in the switching control is terminated when the heat absorption stop condition is satisfied and the heat absorption amount is smaller than a predetermined reference. That is, in the switching control, the heat absorption-amount securing operation can be efficiently performed to suppress the fluctuation of the heating capacity.

As illustrated in FIG. 6, in a case where the heat absorption-amount securing operation is being performed, when the heat absorption stop condition is satisfied, the operation of the low temperature pump 32 is stopped, and the supply amount of the heat medium to the chiller 21 of the heat absorption unit 20 is reduced to zero. By the simple operation control, it is possible to reduce the heat absorption amount through the heat medium in the heat absorption unit 20.

As described above, the vehicle air conditioner 1 according to the first embodiment performs the limiting operation of limiting the amount of released heat in the interior condenser 16 constituting the heating unit 15 in the switching control when the heat pump heating mode is switched to the hot gas heating mode. By performing the limiting operation by the switching control, the heating capacity of the heat pump cycle 10 with the high-pressure refrigerant can be sufficiently increased, and the fluctuation in the heating capacity between the heat pump heating mode and the hot gas heating mode can be suppressed to be a small level.

As illustrated in FIG. 6, as the limiting operation of the switching control, the operation of the interior blower 62 is controlled to limit the supply amount of the blown air to the interior condenser 16 constituting the heating unit 15. By limiting the blown air volume of the blown air by the interior blower 62, it is possible to limit the amount of released heat of the high-pressure part of the heat pump cycle 10 and improve the heating capacity of the high-pressure part of the heat pump cycle 10.

As a limiting operation in the switching control, the opening of the air mix door 64 is controlled to limit the supply amount of the blown air to the interior condenser 16 constituting the heating unit 15. According to the operation of the air mix door 64, the supply amount of the blown air as the heating target to the interior condenser 16 can be limited from the viewpoint of the air blowing path. Therefore, the heating capacity of the heat pump cycle 10 can be sufficiently secured before the mode shifts to the hot gas heating mode by the limiting operation related to the operation control of the air mix door 64.

As indicated by the period after time tc to time te in FIG. 6, the limiting operation in the switching control releases the limitation of the amount of released heat in a case where the pressure of the high-pressure refrigerant in heat pump cycle 10 is equal to or higher than the reference high pressure KPd. The state in which the pressure of the high-pressure refrigerant is equal to or higher than the reference high pressure indicates a state in which the heating capacity of the heat pump cycle 10 is improved to a predetermined reference. Therefore, from the viewpoint of the heating capacity of the heat pump cycle 10, the limiting operation can be terminated in a state where the fluctuation in the heating capacity can be suppressed, and the mode can shift to the hot gas heating mode.

The limiting operation in the switching control releases the limitation of the amount of released heat in a case where the pressure of the low-pressure refrigerant in the heat pump cycle 10 is equal to or higher than the reference low pressure KPs. A state in which the pressure of the low-pressure refrigerant is equal to or higher than the reference low pressure indicates a state in which the amount of work done by the compressor 11 increases to a predetermined reference. Therefore, from the viewpoint of the amount of work done by the compressor 11, the limiting operation can be terminated in a state where the fluctuation in the heating capacity can be suppressed, and the mode can shift to the hot gas heating mode.

As illustrated in FIG. 6, in the switching control related to the switching from the heat pump heating mode to the hot gas heating mode, the limiting operation and the heat absorption-amount securing operation are performed in parallel, and then the mode shifts to the hot gas heating mode. The heating capacity of heat pump cycle 10 can be improved by the limiting operation, and the amount of work done by the compressor 11 can be increased by the heat absorption-amount securing operation. Therefore, by performing the limiting operation and the heat absorption-amount securing operation in parallel, the required period of the switching control can be shortened, and the fluctuation in the heating capacity can be suppressed in a short period.

In the switching control at the time of switching from the heat pump heating mode to the hot gas heating mode, a heat absorption-amount securing operation of securing a heat absorption amount in the heat absorption unit 20 to the same extent as before the switching is performed. By performing the heat absorption-amount securing operation in the switching control, it is possible to increase the density of the suction refrigerant with respect to the compressor 11 to sufficiently increase the amount of work in the compressor 11, and the fluctuation of the heating capacity in the heat pump heating mode and the hot gas heating mode can be suppressed to be a small level.

As described above, in the heat pump cycle 10 in a case where the heat absorption-amount securing operation is being performed, part of the refrigerant discharged from the compressor 11 circulates via the chiller 21. At the same time, the other part of the refrigerant discharged from the compressor 11 circulates through the bypass passage 13. Since the heat absorption-amount securing operation in the switching control is performed in a state in which two circulation paths of the refrigerant similar to those in the hot gas heating mode coexist, shifting from the switching control to the hot gas heating mode can be performed in a short period of time with a simple operation.

As indicated by time td in FIG. 6, the heat absorption-amount securing operation in the switching control is terminated in a case where the heat absorption stop condition is satisfied, and the heat absorption in the heat absorption unit 20 is terminated. The heat absorption stop condition indicates a situation in which the heat absorption amount in the heat absorption unit 20 is small and there is almost no need to continue the heat absorption-amount securing operation. That is, when the heat absorption-amount securing operation is terminated in a case where the heat absorption stop condition is satisfied, the vehicle air conditioner 1 can efficiently execute the switching control and shift to the hot gas heating mode in an aspect in which the fluctuation of the heating capacity is suppressed.

In a case where the heat absorption-amount securing operation is terminated to suppress heat absorption in the heat absorption unit 20, the pressure feed amount of the low temperature pump 32 is reduced to zero. That is, the heat absorption is suppressed by reducing the supply amount of the heat medium constituting the heat absorption target to the chiller 21 constituting the heat absorption unit 20. By adopting this configuration, heat absorption in the heat absorption unit 20 can be suppressed by simple control.

### Second Embodiment

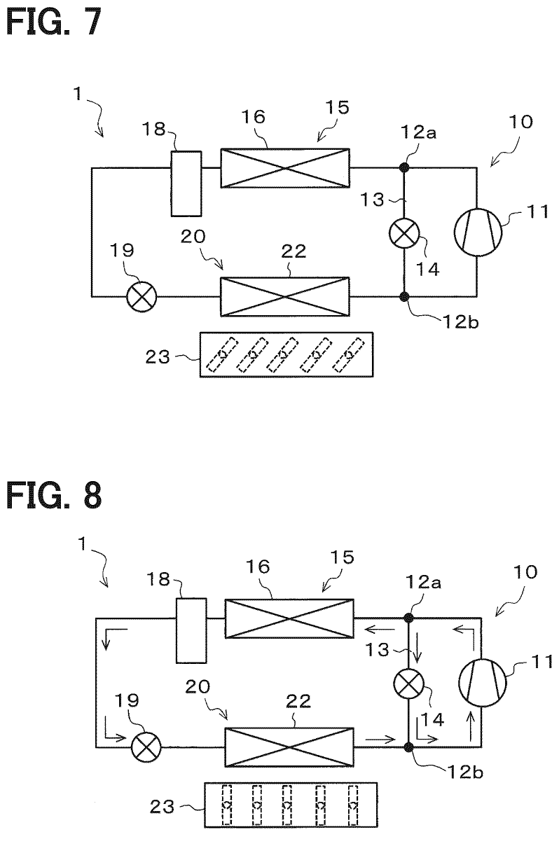

Next, a second embodiment different from the above-described embodiment will be described with reference to FIGS. 7 to 9. As in the first embodiment, a heat pump cycle device according to the second embodiment is applied to a vehicle air conditioner 1 mounted on an electric vehicle. However, in the vehicle air conditioner 1 according to the second embodiment, the configuration of a heat absorption unit 20 is changed from that of the first embodiment described above, and is configured as a vehicle heating device.

Other configurations (a heat pump cycle 10, an interior air conditioning unit 60, etc.) of the vehicle air conditioner 1 according to the second embodiment are the same as those of the above-described embodiment, and thus the description thereof will not be repeated.

As illustrated in FIG. 7, the heat absorption unit 20 of the vehicle air conditioner 1 according to the second embodiment is different from that according to the first embodiment in that it is constituted by an outside air heat absorber 22. In the second embodiment, unlike the first embodiment, the heat medium circuit 30 and the components associated with the heat medium circuit 30 are arranged. That is, the low temperature pump 32, the outside air heat exchanger 33, the heat medium three-way valve 34, and the like disposed in the low temperature circuit 31 of the heat medium circuit 30 are disposed.

The heat pump cycle 10 according to the second embodiment has the same configuration as the first embodiment described above except that the configuration of the heat absorption unit 20 is different. As in the chiller 21 of the first embodiment, the outside air heat absorber 22 is disposed between the outflow port of a low temperature expansion valve 19 and a merging portion 12b. The outside air heat absorber 22 is a heat absorber configured to exchange heat between the refrigerant flowing out of the low temperature expansion valve 19 and outside air present outside the vehicle compartment of the electric vehicle to cause the low-pressure refrigerant to absorb heat of the outside air. That is, the heat absorption target in the heat absorption unit 20 of the second embodiment is outside air.

A method of supplying the outside air to the outside air heat absorber 22 is not particularly limited, and for example, the outside air may be supplied by an operation of an outside air fan (not illustrated), or a configuration using the traveling wind of the electric vehicle may be used.

A shutter device 23 is disposed upstream of the outside air heat absorber 22 in the outside air flow direction. The shutter device 23 is configured by rotatably disposing a plurality of blades in an opening of a frame-shaped frame. The plurality of blades rotates in conjunction with actuation of an electric actuator (not illustrated) to adjust an opening area in the opening of the frame.

As a result, the shutter device 23 can adjust a flow rate of outside air supplied to the outside air heat absorber 22, and can adjust a heat absorption amount in the outside air heat absorber 22. Therefore, the shutter device 23 corresponds to an example of the heat absorption amount adjustment unit.

The vehicle air conditioner 1 according to the second embodiment configured as described above can also realize the heat pump heating mode and the hot gas heating mode. In the heat pump heating mode according to the second embodiment, a bypass expansion valve 14 is brought into a fully closed state, and the low temperature expansion valve 19 is adjusted to the throttling state. At this time, the opening area of the shutter device 23 is secured so that outside air is supplied to the outside air heat absorber 22.

By performing the operation control in this manner, the heat pump cycle 10 can cause the outside air heat absorber 22 constituting the heat absorption unit 20 to absorb heat of the outside air, pump up the absorbed heat, and cause an interior condenser 16 constituting a heating unit 15 to release heat to the blown air. As in the first embodiment, the heat pump heating mode according to the second embodiment corresponds to an example of the first heating mode.

In the hot gas heating mode according to the second embodiment, the refrigerant is circulated in the heat pump cycle 10 with the bypass expansion valve 14 and the low temperature expansion valve 19 set in the determined throttling states. At this time, the shutter device 23 is controlled so that the opening area is minimized, and realizes a state in which the supply amount of outside air to the outside air heat absorber 22 is minimized.

Accordingly, in the heat pump cycle 10 in the hot gas heating mode according to the second embodiment, a refrigerant circuit in which a path through which the refrigerant circulates via the interior condenser 16 and a path through which the refrigerant circulates via a bypass passage 13 coexist is configured. That is, part of the refrigerant discharged from the compressor 11 flows and circulates through the compressor 11, a branch portion 12a, the interior condenser 16, a receiver 18, the low temperature expansion valve 19, the outside air heat absorber 22, the merging portion 12b, and the compressor 11 in this order. At the same time, the other part of the refrigerant discharged from the compressor 11 flows and circulates through the compressor 11, the branch portion 12a, the bypass passage 13, the bypass expansion valve 14, the merging portion 12b, and the compressor 11 in this order.

As described above, in the hot gas heating mode, the refrigerants having different enthalpies, such as the refrigerant having low enthalpy flowing out of the outside air heat absorber 22 and the refrigerant having high enthalpy flowing out of the bypass passage 13, are mixed and sucked into the compressor 11. Therefore, as in the first embodiment, in the hot gas heating mode, even when the heat absorption amount from the heat absorption source (outside air) is small, the heat generated by the work done by the compressor 11 can be effectively used to heat the blown air, so that the vehicle compartment can be heated. That is, the hot gas heating mode according to the second embodiment also corresponds to an example of the second heating mode.

The vehicle air conditioner 1 according to the second embodiment is assumed to have insufficient heating capacity during the execution of the heat pump heating mode. For example, in a case where the outside air temperature is excessively lower than a required heating capacity, the heat pump heating mode is not effective, and it may be desirable to switch to the hot gas heating mode.

Therefore, also in the second embodiment, when the heat pump heating mode is switched to the hot gas heating mode, switching control for suppressing fluctuation in heating capacity is performed.

When the switching control is started in the vehicle air conditioner 1 according to the second embodiment, the rotation speed of the compressor 11 is controlled to be a predetermined rotation speed, and the throttle openings of the bypass expansion valve 14 and the low temperature expansion valve 19 are controlled to be predetermined values, as in the first embodiment.

With the start of the switching control, the operation control of an interior blower 62 and an air mix door 64 is performed, and the limiting operation similar to that in the first embodiment is performed. In the switching control of the second embodiment, as the heat absorption-amount securing operation, in order to secure the supply amount of outside air to the outside air heat absorber 22, the operation of the shutter device 23 is performed so as to increase the opening area as much as possible.

The vehicle air conditioner 1 according to the second embodiment thus achieves circulation of the refrigerant in the heat pump cycle 10 in an aspect illustrated in FIG. 8. In the first state, the amount of released heat in the heating unit 15 is limited by the limiting operation, and the heat absorption amount in the outside air heat absorber 22 is secured by the heat absorption-amount securing operation. As a result, from the viewpoint of the high-pressure part and the low-pressure part of the heat pump cycle 10, the heating capacity after completion of the switching can be increased to a level that is equivalent to a level before the switching, and the fluctuation in the heating capacity can be suppressed.

When shifting to the second state in the switching control of the second embodiment, the heat absorption-amount securing operation performed in the first state is stopped, and only the limiting operation is performed. Shifting from the first state to the second state in the switching control is performed in a case where the heat absorption amount in the heat absorption unit 20 decreases, as in the first embodiment described above. Therefore, the shift timing is determined by the relationship between the temperature of the low-pressure refrigerant in the outside air heat absorber 22 and the outside air temperature.

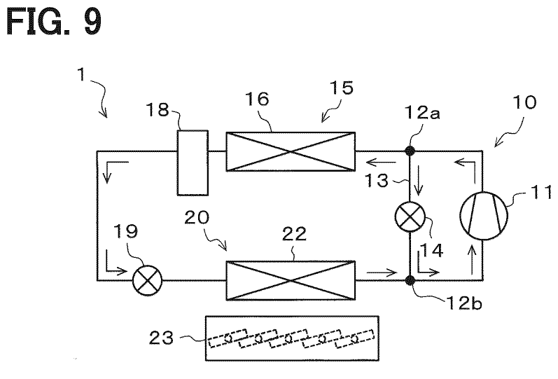

From the first state of the switching control according to the second embodiment, the operation control of the shutter device 23 minimizes the supply amount of outside air to the outside air heat absorber 22, and ends the heat absorption-amount securing operation. As a result, as illustrated in FIG. 9, the second state of the switching control according to the second embodiment is realized. Even in the second state of the switching control, the circulation of the refrigerant and the limiting operation are continuously performed.

As a result, it is possible to increase the heating capacity to a state in which the same heating capacity as that before switching can be exhibited by limiting the amount of released heat while suppressing the energy consumption of the heat absorption-amount securing operation in a state in which the heat absorption amount is decreased.

That is, also in the vehicle air conditioner 1 according to the second embodiment, the switching control is performed at the time of switching from the heat pump heating mode to the hot gas heating mode, so that it is possible to suppress the fluctuation of the heating capacity due to the switching of the operation mode.

As described above, according to the vehicle air conditioner 1 according to the second embodiment, even in a case where the configuration of the heat absorption unit 20 is changed, it is possible to obtain the operational effects obtained from the configuration and operation common to the above-described embodiment.

### Third Embodiment

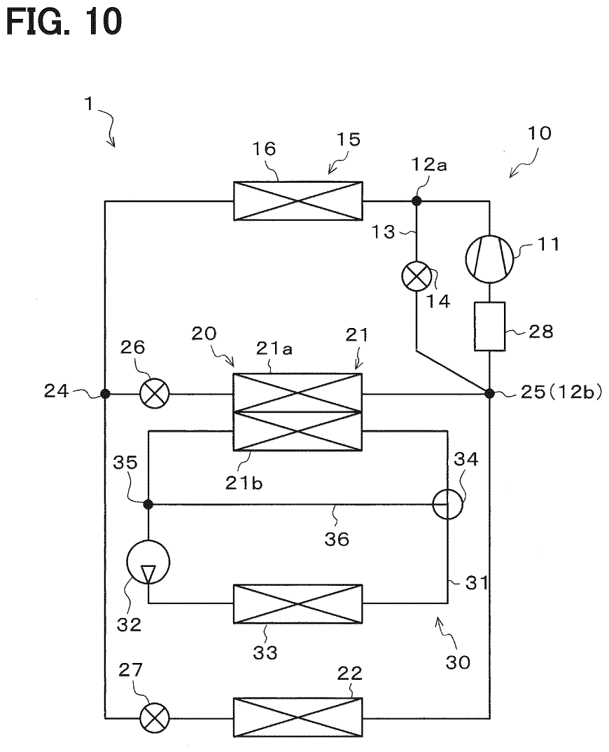

Next, a third embodiment different from the above-described embodiments will be described with reference to FIGS. 10 to 12. In a vehicle air conditioner 1 according to the third embodiment, the configuration of a heat pump cycle 10 is changed from the heat pump cycle 10 in the above-described embodiments. Other configurations (a heat medium circuit 30, an interior air conditioning unit 60, and the like) of the vehicle air conditioner 1 according to the third embodiment are the same as those of the above-described embodiments, and thus the description thereof will not be repeated.

As illustrated in FIG. 10, the vehicle air conditioner 1 according to the third embodiment includes a heat pump cycle 10, a heat medium circuit 30, an interior air conditioning unit 60, and a control device 70. The configurations of the heat medium circuit 30, the interior air conditioning unit 60, the control device 70, and the like are the same as those of the first embodiment described above, and thus the description thereof will be omitted again.

The heat pump cycle 10 according to the third embodiment includes a compressor 11, a bypass passage 13, a bypass expansion valve 14, an interior condenser 16, a chiller 21, an outside air heat absorber 22, a first expansion valve 26, a second expansion valve 27, and an accumulator 28. That is, unlike the above-described embodiments, the heat pump cycle 10 according to the third embodiment is configured as a parallel circuit in which the chiller 21 and the outside air heat absorber 22 are connected in parallel in the low-pressure flow path, and is configured as an accumulator cycle.

In the heat pump cycle 10 according to the third embodiment, a branch portion 12a is connected to the discharge port of the compressor 11. Since the configurations of the compressor 11 and the branch portion 12a are similar to those of the first embodiment, the description thereof will be omitted again.

An inlet of the interior condenser 16 constituting a heating unit 15 is connected to one outflow port of the branch portion 12a. The bypass passage 13 and the bypass expansion valve 14 are connected to the other outflow port of the branch portion 12a. The configuration and arrangement of the interior condenser 16 and the configurations of the bypass passage 13 and the bypass expansion valve 14 are similar to those of the first embodiment described above.

A first connection portion 24 having a three-way joint shape is disposed at the outflow port of the interior condenser 16. The first connection portion 24 has one inflow port and two outflow ports. The first expansion valve 26 and the refrigerant passage 21a of the chiller 21 are connected to one of the outflow ports of the first connection portion 24. The second expansion valve 27 and the outside air heat absorber 22 are connected to the other of the outflow ports in the first connection portion 24.

The first expansion valve 26 and the second expansion valve 27 are electric expansion valves configured as in the above-described low temperature expansion valve 19. Therefore, each of the first expansion valve 26 and the second expansion valve 27 includes a valve body and an electric actuator, and the operation of each valve is controlled by a control pulse output from the control device 70. Each of the first expansion valve 26 and the second expansion valve 27 has a fully open function and a fully closed function.

The chiller 21 constituting the heat absorption unit 20 is connected to the outflow port of the first expansion valve 26. As in the first embodiment, the chiller 21 includes a refrigerant passage 21a and a heat medium passage 21b, and exchanges heat between the refrigerant flowing through the refrigerant passage 21a and the heat medium flowing through the heat medium passage 21b. A second connection portion 25 having a four-way joint shape is connected to the outlet of the chiller 21 in the refrigerant passage 21a.

The heat medium circulating in the heat medium passage 21b is a heat medium circulating in the low temperature circuit 31, as in the first embodiment. The low temperature circuit 31 includes a low temperature pump 32, an outside air heat exchanger 33, a heat medium three-way valve 34, and a bypass connection portion 35, and has a configuration similar to that of the first embodiment.

Therefore, according to the heat pump cycle 10 of the third embodiment, by using the chiller 21 as the heat absorption unit 20, the heat of the outside air as the heat absorption source can be absorbed by the low-pressure refrigerant via the heat medium of the low temperature circuit 31.

The outside air heat absorber 22 constituting the heat absorption unit 20 is connected to the outflow port of the second expansion valve 27. As in the second embodiment, the outside air heat absorber 22 exchanges heat between the heat medium flowing through the outside air heat absorber 22 and the outside air outside the vehicle compartment. The second connection portion 25 having a four-way joint shape is connected to the outlet of the outside air heat absorber 22.

Therefore, according to the heat pump cycle 10 of the third embodiment, by using the outside air heat absorber 22 as the heat absorption unit 20, the heat of the outside air as the heat absorption source can be absorbed by the low-pressure refrigerant.

The second connection portion 25 is formed in a four-way joint shape, and has three inflow ports and one outflow port. One of the inflow ports of the second connection portion 25 is connected to the bypass passage 13 and the other end of the bypass expansion valve 14. Another of the inflow ports of the second connection portion 25 is connected to the outlet of the refrigerant passage 21a of the chiller 21. Another inflow port of the second connection portion 25 is connected to the outlet of the outside air heat absorber 22.

The outflow port of the second connection portion 25 is connected to the inflow port of the accumulator 28. That is, the second connection portion 25 constitutes a merging portion 12b that merges the flow of the refrigerant passing through the bypass passage 13, the flow of the refrigerant passing through the chiller 21, and the flow of the refrigerant passing through the outside air heat absorber 22, and guides the merged flows to the accumulator 28.

The inlet of the accumulator 28 is connected to the outflow port of the second connection portion 25 constituting the merging portion 12b. The accumulator 28 is a low-pressure gas-liquid separator configured to separate the low-pressure refrigerant flowing out of the second connection portion 25 into gas and liquid, and stores the separated liquid-phase refrigerant as a surplus refrigerant in the cycle. The suction port of the compressor 11 is connected to the gas-phase refrigerant outlet of the accumulator 28.

The vehicle air conditioner 1 according to the third embodiment configured as described above can also perform the heat pump heating mode and the hot gas heating mode as the operation modes for heating the blown air as the heating target.

An example of a heat pump heating mode according to the third embodiment will be described. In the heat pump heating mode according to the third embodiment, the bypass expansion valve 14 and the first expansion valve 26 are brought into a fully closed state, and the second expansion valve 27 is brought into a predetermined throttling state. At this time, in the heat medium circuit 30, the circulation of the heat medium may be continued or the circulation of the heat medium may be stopped by the operation control of the low temperature pump 32.

Accordingly, in the heat pump cycle 10 in the heat pump heating mode according to the third embodiment, the refrigerant flows and circulates through the compressor 11, the branch portion 12a, the interior condenser 16, the first connection portion 24, the second expansion valve 27, the outside air heat absorber 22, the second connection portion 25, and the accumulator 28 in this order.

That is, in the heat pump heating mode according to the third embodiment, a refrigerant circuit including the outside air heat absorber 22 as a heat absorber and the interior condenser 16 as a radiator is configured, and a heating of heating blown air using the outside air as a heat absorption source is realized. The heat pump heating mode according to the third embodiment corresponds to an example of the first heating mode.

As another example of the heat pump heating mode according to the third embodiment, it is possible to adopt a configuration in which the bypass expansion valve 14 and the second expansion valve 27 are brought into a fully closed state, and the first expansion valve 26 is brought into a predetermined throttling state. In this case, the heat medium circuit 30 is controlled so that the heat medium circulates through the chiller 21 and the outside air heat exchanger 33. According to this configuration, it is possible to realize the heat pump heating mode using outside air as a heat absorption source.

Next, a hot gas heating mode in the third embodiment will be described. In the hot gas heating mode according to the third embodiment, control is performed so that the bypass expansion valve 14 and the first expansion valve 26 are brought into respectively determined throttling states, and the second expansion valve 27 is brought into a fully closed state. At this time, the heat medium circuit 30 is controlled so as to stop the circulation of the heat medium.

According to this configuration, in the hot gas heating mode according to the third embodiment, the circuit is switched to a refrigerant circuit in which a path through which the refrigerant circulates via the interior condenser 16 and a path through which the refrigerant circulates via the bypass passage 13 coexist.

That is, part of the refrigerant discharged from the compressor 11 flows and circulates through the compressor 11, the branch portion 12a, the interior condenser 16, the first connection portion 24, the first expansion valve 26, the chiller 21, the second connection portion 25, the accumulator 28, and the compressor 11 in this order. At the same time, the other part of the refrigerant discharged from the compressor 11 flows and circulates through the compressor 11, the branch portion 12a, the bypass passage 13, the bypass expansion valve 14, the second connection portion 25, the accumulator 28, and the compressor 11 in this order.

That is, in the hot gas heating mode according to the third embodiment, the refrigerants having different enthalpies, such as the refrigerant having low enthalpy flowing out of the chiller 21 and the refrigerant having high enthalpy flowing out of the bypass passage 13, are mixed at the merging portion 12b. By mixing the refrigerants having different enthalpies and sucking the mixed refrigerant into the compressor 11, the amount of work done by the compressor 11 can be increased, and the heating capacity for the heating target can be improved. The hot gas heating mode according to the third embodiment corresponds to an example of the second heating mode.

The vehicle air conditioner 1 according to the third embodiment is assumed to have insufficient heating capacity during the execution of the heat pump heating mode. For example, in a case where the outside air temperature is excessively lower than a required heating capacity, the heat pump heating mode is not effective, and it may be desirable to switch to the hot gas heating mode.

Therefore, also in the third embodiment, when the heat pump heating mode is switched to the hot gas heating mode, switching control for suppressing fluctuation in heating capacity is performed.

In the vehicle air conditioner 1 according to the third embodiment, when the switching control is started from the state of the heat pump heating mode, the rotation speed of the compressor 11 is controlled to be a predetermined rotation speed, as in the first embodiment. At this time, the throttle openings of the bypass expansion valve 14, the first expansion valve 26, and the second expansion valve 27 are controlled to be predetermined values respectively set. In the heat medium circuit 30, the circulation of the heat medium through the chiller 21 is stopped by stopping the operation of the low temperature pump 32.

With the start of the switching control, the operation control of the interior blower 62 and the air mix door 64 is performed, and the limiting operation similar to that in the above-described embodiments is performed. In the switching control of the third embodiment, heat absorption from outside air in the outside air heat absorber 22 is performed as the heat absorption-amount securing operation.

In a case where the shutter device 23 is disposed for the outside air heat absorber 22, as in the second embodiment, in order to secure the supply amount of the outside air to the outside air heat absorber 22, the operation of the shutter device 23 is performed so as to increase the opening area as much as possible.

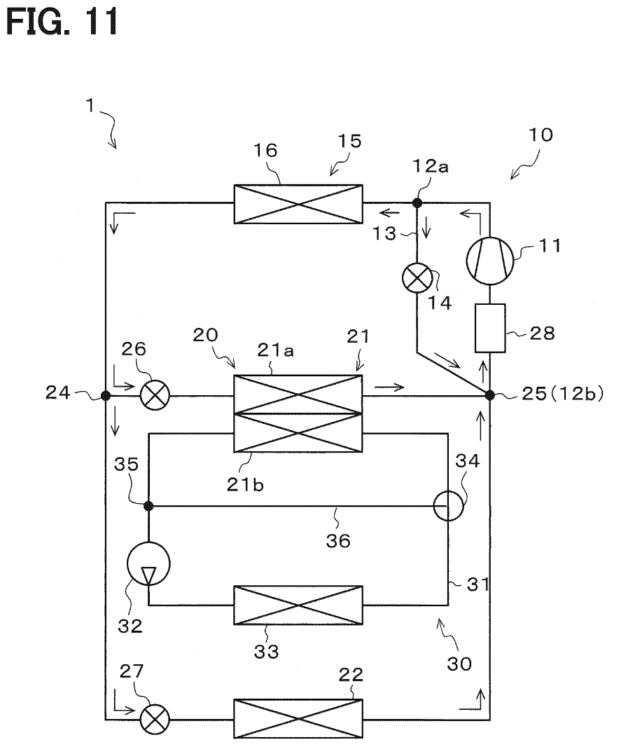

The vehicle air conditioner 1 according to the third embodiment thus achieves circulation of the refrigerant in the heat pump cycle 10 in an aspect illustrated in FIG. 11. In the first state, the amount of released heat in the heating unit 15 is limited by the limiting operation, and the heat absorption amount in the outside air heat absorber 22 is secured by the heat absorption-amount securing operation. As a result, from the viewpoint of the high-pressure part and the low-pressure part of the heat pump cycle 10, the heating capacity after completion of the switching can be increased to a level that is equivalent to a level before the switching, and the fluctuation in the heating capacity before and after the switching can be suppressed.

When shifting to the second state in the switching control of the third embodiment, the heat absorption-amount securing operation performed in the first state is stopped, and only the limiting operation is performed. Shifting from the first state to the second state in the switching control is performed in a case where the heat absorption amount in the heat absorption unit 20 decreases, as in the above-described embodiments. Therefore, the shift timing is determined by the relationship between the temperature of the low-pressure refrigerant in the outside air heat absorber 22 and the outside air temperature.

Shifting of the switching control according to the third embodiment from the first state to the second state (that is, the end of the heat absorption-amount securing operation) is realized by changing the refrigerant flow path in the heat pump cycle 10. As illustrated in FIG. 11, in a case where the heat absorption-amount securing operation is being performed, part of the refrigerant having passed through the first connection portion 24 flows through the second expansion valve 27 and the outside air heat absorber 22, whereby heat is absorbed from the outside air. When the heat absorption-amount securing operation is terminated, the refrigerant path is switched so that all the refrigerant passing through the first connection portion 24 passes through the first expansion valve 26 and the chiller 21.

Specifically, the state of the second expansion valve 27 is switched from the throttling state in the first state to the fully closed state. As a result, since the supply of the low-pressure refrigerant to the outside air heat absorber 22 is stopped, the heat absorption-amount securing operation is terminated. Even in the second state of the switching control, the circulation of the refrigerant and the limiting operation are continuously performed.

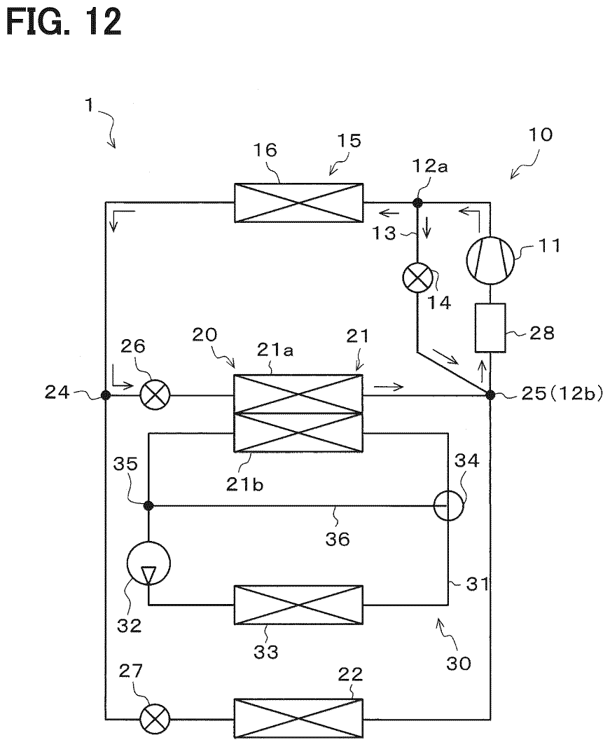

As a result, as illustrated in FIG. 12, the second state of the switching control according to the third embodiment is realized. It is possible to increase the heating capacity to a state in which the same heating capacity as that before switching can be exhibited by limiting the amount of released heat while suppressing the energy consumption of the heat absorption-amount securing operation in a state in which the heat absorption amount is decreased.

That is, also in the vehicle air conditioner 1 according to the third embodiment, the switching control is performed at the time of switching from the heat pump heating mode to the hot gas heating mode, so that it is possible to suppress the fluctuation of the heating capacity due to the switching of the operation mode.

As described above, according to the vehicle air conditioner 1 of the third embodiment, even in a case where the heat pump cycle 10 in which the plurality of heat absorbers constituting the heat absorption unit 20 is disposed in parallel is used, it is possible to obtain the operational effects obtained from the configuration and operation common to the above-described embodiments.

As illustrated in FIGS. 11 and 12, in the vehicle air conditioner 1 according to the third embodiment, the flow of the refrigerant passing through the outside air heat absorber 22 used in the heat absorption-amount securing operation is switched to end the heat absorption-amount securing operation. Upon completion of the heat absorption-amount securing operation, the flow of the refrigerant passing through the outside air heat absorber 22 that has absorbed heat in the heat absorption-amount securing operation is switched to the flow of the refrigerant passing through the chillers 21 disposed in parallel, and the refrigerant bypasses the outside air heat absorber 22, so that the supply of the low-pressure refrigerant to the outside air heat absorber 22 is stopped.

As described above, in the vehicle air conditioner 1 according to the third embodiment, the plurality of heat absorbers (chiller 21, outside air heat absorber 22) constituting the heat absorption unit 20 is disposed in parallel, and the heat absorption-amount securing operation using any one of the heat absorbers is performed. In a case where the heat absorption amount securing degree operation is terminated, the low-pressure refrigerant flow path is switched from the configuration passing through any one of the heat absorbers (outside air heat absorber 22) to the configuration passing through any other heat absorber (chiller 21). As a result, the heat absorption-amount securing operation can be terminated by switching the refrigerant flow path, and heat absorption related to the heat absorption-amount securing operation can be suppressed by simple control.

### Fourth Embodiment

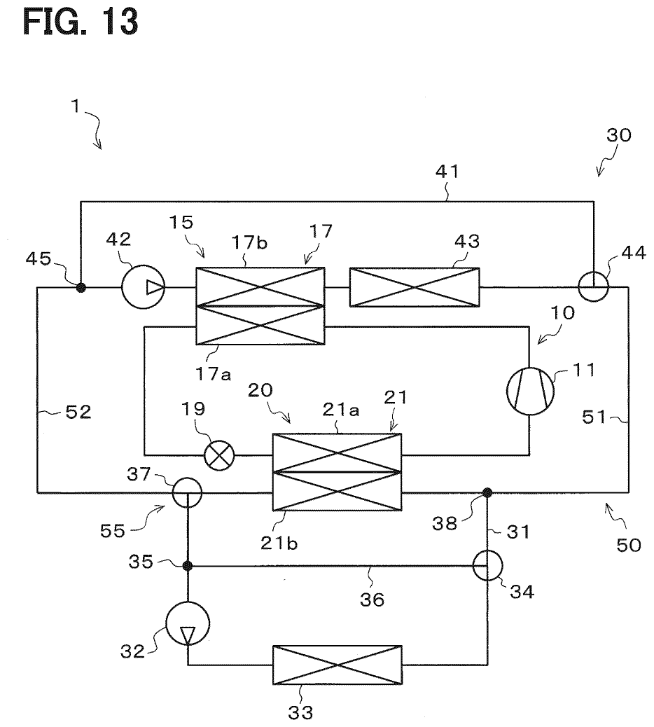

Next, a fourth embodiment different from the above-described embodiments will be described with reference to FIG. 13 to 16. The fourth embodiment is an embodiment in which the heat pump cycle device according to the present disclosure is applied to a vehicle air conditioner 1 of an electric vehicle as in the above-described embodiments. As in the above-described embodiments, the fourth embodiment is characterized in that a fluctuation in heating capacity when switching a plurality of operation modes for heating a heating target is suppressed.

Also in the fourth embodiment, an operation mode in which heat absorbed by the low-pressure part of a heat pump cycle 10 is pumped up and used for heating a heating target, and an operation mode in which an amount of work done by a compressor 11 is increased using part of the refrigerant discharged from the compressor 11 to exert heating capacity are performed. That is, the operation mode in the fourth embodiment is based on the idea same as that of the above-described embodiments in the above points although details are different.

The vehicle air conditioner 1 according to the fourth embodiment includes the heat pump cycle 10, a heat medium circuit 30, an interior air conditioning unit 60, and a control device 70. In the fourth embodiment, configurations of the heat pump cycle 10 and the heat medium circuit 30 are different from those of the above-described embodiments. In other words, other configurations (the interior air conditioning unit 60, the control device 70, etc.) of the vehicle air conditioner 1 according to the fourth embodiment are basically similar to those of the above-described embodiments, and thus the description thereof will not be repeated.

As illustrated in FIG. 13, the heat pump cycle 10 of the vehicle air conditioner 1 according to the fourth embodiment includes the compressor 11, a heat-medium refrigerant heat exchanger 17, a low temperature expansion valve 19, and a chiller 21. The compressor 11 has a configuration similar to that of the above-described embodiments. Therefore, a detailed description of the compressor 11 is omitted.

A refrigerant inlet of the heat-medium refrigerant heat exchanger 17 is connected to a discharge port of the compressor 11. The heat-medium refrigerant heat exchanger 17 includes a refrigerant passage 17a through which the high-pressure refrigerant discharged from the compressor 11 flows, and a heat medium passage 17b through which the heat medium circulating in a high temperature circuit 41 constituting the heat medium circuit 30 flows.

The heat-medium refrigerant heat exchanger 17 is a condenser configured to exchange heat between the high-pressure refrigerant flowing through the refrigerant passage 17a and the heat medium flowing through the heat medium passage 17b to condense the refrigerant. That is, the heat-medium refrigerant heat exchanger 17 releases heat of the high-pressure refrigerant discharged from the compressor 11 to the heat medium circulating in the heat medium circuit 30 to heat the heat medium. Therefore, the heat-medium refrigerant heat exchanger 17 constitutes part of a heating unit 15.

The low temperature expansion valve 19 is connected to the outlet of the refrigerant passage 17a of the heat-medium refrigerant heat exchanger 17. The configuration of the low temperature expansion valve 19 is similar to that of the above-described embodiments, and includes a valve body and an electric actuator. The operation of the low temperature expansion valve 19 is controlled by a control pulse output from the control device 70. The low temperature expansion valve 19 has a fully open function and a fully closed function.

An inflow port of a refrigerant passage 21a of the chiller 21 is connected to an outflow port of the low temperature expansion valve 19. The chiller 21 includes the refrigerant passage 21a and a heat medium passage 21b as in the above-described embodiments, and exchanges heat between the refrigerant flowing through the refrigerant passage 21a and the heat medium flowing through the heat medium passage 21b. Therefore, the chiller 21 constitutes part of a heat absorption unit 20 causing the low-pressure refrigerant flowing through the refrigerant passage 21a to absorb heat of the heat medium flowing through the heat medium passage 21b. A suction port of the compressor 11 is connected to an outflow port in the refrigerant passage 21a of the chiller 21.

The heat pump cycle 10 according to the fourth embodiment configured as described above can pump up heat absorbed by the low-pressure heat absorption unit 20 and release the heat by the high-pressure heating unit 15 to be used for heating the heating target.

Next, the heat medium circuit 30 of the vehicle air conditioner 1 according to the fourth embodiment will be described. As illustrated in FIG. 13, the heat medium circuit 30 according to the fourth embodiment includes a low temperature circuit 31, a high temperature circuit 41, a heat-medium connection flow path 50, and a heat medium flow rate adjustment unit 55.

As in the first embodiment described above, the low temperature circuit 31 according to the fourth embodiment includes the heat medium passage 21b of the chiller 21, a low temperature pump 32, an outside air heat exchanger 33, a heat medium three-way valve 34, a bypass connection portion 35, and a heat medium bypass flow path 36. In the low temperature circuit 31, the positional relationship between the chiller 21, and the low temperature pump 32 to the heat medium bypass flow path 36 is the same as that in the above-described embodiments.

Therefore, in the low temperature circuit 31 according to the fourth embodiment, the heat medium absorbed by the chiller 21 is circulated via the outside air heat exchanger 33, whereby the heat of the outside air can be absorbed by the low-pressure refrigerant via the heat medium.

As illustrated in FIG. 13, in the low temperature circuit 31 according to the fourth embodiment, a low temperature flow rate adjustment unit 37 and a low temperature connection portion 38 are disposed in addition to the chiller 21 and the low temperature pump 32 to the heat medium bypass flow path 36 described above.

The low temperature flow rate adjustment unit 37 is an electric three-way flow rate adjustment valve having three outflow/inflow ports, and is configured to be able to continuously adjust a passage area ratio of each outflow port. The operation of the low temperature flow rate adjustment unit 37 is controlled by a control signal output from the control device 70.

The low temperature flow rate adjustment unit 37 is disposed between the outlet of the chiller 21 in the heat medium passage 21b and the bypass connection portion 35. That is, the outlet of the heat medium passage 21b of the chiller 21 is connected to one of the outflow/inflow ports of the low temperature flow rate adjustment unit 37, and one of the outflow/inflow ports of the bypass connection portion 35 is connected to the other of the outflow/inflow ports of the low temperature flow rate adjustment unit 37. A second connection flow path 52 is connected to another outflow/inflow port of the low temperature flow rate adjustment unit 37. The second connection flow path 52 will be described later.

The low temperature connection portion 38 is formed in a three-way joint shape having three inflow/outflow ports, and is disposed between the inlet of the chiller 21 in the heat medium passage 21b and the heat medium three-way valve 34. Therefore, the inlet of the heat medium passage 21b of the chiller 21 is connected to one inflow/outflow port of the low temperature connection portion 38, and one of the outflow/inflow ports of the heat medium three-way valve 34 is connected to another inflow/outflow port of the low temperature connection portion 38. A first connection flow path 51 is connected to another inflow/outflow port of the low temperature connection portion 38. The first connection flow path 51 will be described later.

According to the low temperature circuit 31 of the fourth embodiment configured as described above, the circulation aspect of the plurality of heat media can be realized by controlling the operation of the heat medium three-way valve 34 and the like. As one of the circulation aspects of the heat medium in the low temperature circuit 31, the heat medium flows and circulates through the low temperature pump 32, the outside air heat exchanger 33, the heat medium three-way valve 34, the low temperature connection portion 38, the chiller 21, the low temperature flow rate adjustment unit 37, the bypass connection portion 35, and the low temperature pump 32 in this order.

As another circulation aspect of the heat medium in the low temperature circuit 31, an aspect in which the heat medium flows and circulates through the low temperature pump 32, the outside air heat exchanger 33, the heat medium three-way valve 34, the heat medium bypass flow path 36, the bypass connection portion 35, and the low temperature pump 32 in this order can be realized. Therefore, the low temperature circuit 31 according to the fourth embodiment corresponds to an example of the second circuit, and the outside air heat exchanger 33 according to the fourth embodiment corresponds to an example of the heat medium heat absorber. The low temperature circuit 31 constitutes the heat absorption unit 20 together with the chiller 21.

Next, a configuration of the high temperature circuit 41 of the heat medium circuit 30 according to the fourth embodiment will be described with reference to FIG. 13. The high temperature circuit 41 according to the fourth embodiment is a circuit, of the heat medium circuit 30, in which the heat medium circulates through the heat-medium refrigerant heat exchanger 17 constituting the heating unit 15. In the high temperature circuit 41 according to the fourth embodiment, a high temperature pump 42, a heater core 43, a high temperature flow rate adjustment unit 44, and a high temperature connection portion 45 are disposed in addition to the heat medium passage 17b of the heat-medium refrigerant heat exchanger 17.

In the high temperature circuit 41 according to the fourth embodiment, the high temperature pump 42 is connected to the inlet of the heat medium passage 17b of the heat-medium refrigerant heat exchanger 17. The high temperature pump 42 is a heat medium pressure feeding unit configured as in the above-described low temperature pump 32. The pressure feeding capability of the high temperature pump 42 is controlled by a control voltage output from the control device 70.

The heater core 43 is connected to an inlet of the heat medium passage 17b of the heat-medium refrigerant heat exchanger 17. As in the interior condenser 16 in the above-described embodiments, the heater core is disposed in an air conditioning case 61 of the interior air conditioning unit 60. The heater core 43 is an air heat exchange unit configured to exchange heat between the heat medium flowing out of the heat-medium refrigerant heat exchanger 17 and the blown air passing through a cooler core 33a. In the heater core 43, the heat of the heat medium flowing out of the heat-medium refrigerant heat exchanger 17 is released to the blown air, and the blown air is heated. Therefore, the heater core 43 corresponds to an example of the heat medium radiator.

The high temperature flow rate adjustment unit 44 is connected to the heat medium outlet of the heater core 43. As in the low temperature flow rate adjustment unit 37, the high temperature flow rate adjustment unit 44 is configured by an electric three-way flow rate adjustment valve having three outflow/inflow ports. The operation of the high temperature flow rate adjustment unit 44 is controlled by a control signal output from the control device 70.

The outlet of the heat medium passage 17b of the heat-medium refrigerant heat exchanger 17 is connected to one of the outflow/inflow ports of the high temperature flow rate adjustment unit 44, and one of the outflow/inflow ports of the three-way joint high temperature connection portion 45 is connected to another of the outflow/inflow ports of the high temperature flow rate adjustment unit 44. The first connection flow path 51 constituting the heat-medium connection flow path 50 is connected to the remaining outflow/inflow port of the high temperature flow rate adjustment unit 44.

As illustrated in FIG. 13, the high temperature connection portion 45 having a three-way joint shape is connected to a suction port of high temperature pump 42. The configuration of the high temperature connection portion 45 is similar to that of each of the branch portion 12a, the low temperature connection portion 38, and the like described above. As described above, the suction port of the high temperature pump 42 is connected to one of the inflow/outflow ports in the high temperature connection portion 45, and another of the inflow/outflow ports in the high temperature flow rate adjustment unit 44 is connected to another of the inflow/outflow ports in the high temperature connection portion 45. The second connection flow path 52 is connected to the remaining inflow/outflow port of high temperature connection portion 45.

In the high temperature circuit 41 according to the fourth embodiment configured as described above, the heat medium can flow and circulate through the high temperature pump 42, the heat-medium refrigerant heat exchanger 17, the heater core 43, the high temperature flow rate adjustment unit 44, the high temperature connection portion 45, and the high temperature pump 42 in this order.

That is, according to the high temperature circuit 41 of the fourth embodiment, the heat medium heated by the heat of the high-pressure refrigerant in the heat-medium refrigerant heat exchanger 17 flows into the heater core 43, and the blown air can be heated by the heat of the heat medium in the heater core 43. Therefore, the high temperature circuit 41 according to the fourth embodiment corresponds to an example of the first circuit.

The heat medium circuit 30 according to the fourth embodiment includes the heat-medium connection flow path 50 that connects the high temperature circuit 41 and the low temperature circuit 31 so that the heat medium is allowed to flow in and out. As illustrated in FIG. 13, the heat-medium connection flow path 50 includes the first connection flow path 51 and the second connection flow path 52.

As described above, the first connection flow path 51 connects one of the inflow/outflow ports of the high temperature flow rate adjustment unit 44 disposed in the high temperature circuit 41 and one of the inflow/outflow ports of the low temperature connection portion 38 disposed in the low temperature circuit 31. Therefore, by controlling the operation of the high temperature flow rate adjustment unit 44 and opening the inflow/outflow port of the high temperature flow rate adjustment unit 44, the heat medium is allowed to flow in and out between the high temperature circuit 41 and the low temperature circuit 31.

The second connection flow path 52 connects one of inflow/outflow ports of the low temperature flow rate adjustment unit 37 disposed in the low temperature circuit 31 and one of inflow/outflow ports of the high temperature connection portion 45 disposed in the high temperature circuit 41. Therefore, by controlling the operation of the low temperature flow rate adjustment unit 37 and opening the inflow/outflow ports of the low temperature flow rate adjustment unit 37, the heat medium is allowed to flow in and out between the high temperature circuit 41 and the low temperature circuit 31.

Since the low temperature flow rate adjustment unit 37 and the high temperature flow rate adjustment unit 44 are controlled when the heat medium flows in and out through the heat-medium connection flow path 50, each of them corresponds to an example of the flow rate adjustment unit.

In the fourth embodiment, two types of heating modes are included as operation modes of the vehicle air conditioner 1 configured to heat the blown air as the heating target. The vehicle air conditioner 1 according to the fourth embodiment can heat the vehicle compartment using the independent circulation heating mode and the circuit cooperation heating mode.

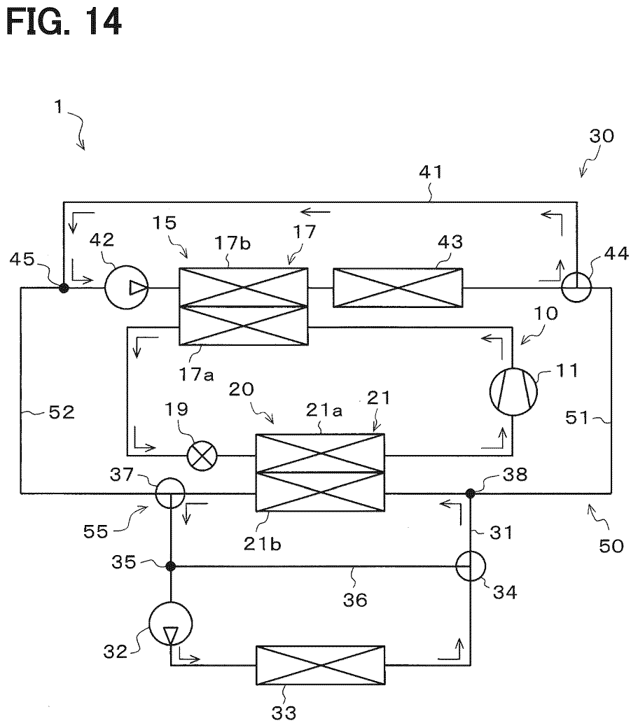

First, the independent circulation heating mode in the vehicle air conditioner 1 according to the fourth embodiment will be described with reference to FIG. 14. The independent circulation heating mode according to the fourth embodiment is an operation mode for heating the blown air by pumping up heat absorbed from a heat absorption source (air in the vehicle compartment) via the heat medium of the low temperature circuit 31 and radiating heat to the blown air by the heater core 43 via the heat medium of the high temperature circuit 41. Accordingly, the independent circulation heating mode according to the fourth embodiment can be regarded as an aspect of the heat pump heating mode.

The control device 70 causes the compressor 11 to compress and discharge the refrigerant, and brings the low temperature expansion valve 19 into a throttling state. Therefore, in the heat pump cycle 10 in the independent circulation heating mode, the circuit is switched to the refrigerant circuit in which the refrigerant flows and circulates through the compressor 11, the heat-medium refrigerant heat exchanger 17, the low temperature expansion valve 19, the chiller 21, and the compressor 11 in this order.

The control device 70 controls the refrigerant discharge performance of the compressor 11 so that the high pressure Pd detected by the high-pressure pressure sensor 72d approaches the target high pressure PDO. The target high pressure PDO is determined based on the target blowing temperature TAO with reference to a control map stored in advance in the control device 70.

The control device 70 controls the throttle opening of the low temperature expansion valve 19 so that the degree of superheating SHC of the refrigerant at the outlet of the refrigerant passage 21a in the chiller 21 approaches the reference degree of superheating KSH within a range in which the refrigerant evaporating temperature in the chiller 21 is lower than the outside air temperature Tam.

Regarding the low temperature circuit 31 of the heat medium circuit 30, the control device 70 determines the pressure feeding capability of the low temperature pump 32 and the opening area ratio of the three outflow/inflow ports of the heat medium three-way valve 34 so that the heat absorption amount necessary for achieving the target blowing temperature can be secured. At this time, the control device 70 controls the operation of the low temperature flow rate adjustment unit 37 so that the inflow/outflow ports of the second connection flow path 52 are brought into a fully closed state, and the chiller 21 and the inflow/outflow ports of the bypass connection portion 35 communicate with each other.

As a result, in the low temperature circuit 31 in the independent circulation heating mode, the heat medium flows and circulates through the low temperature pump 32, the outside air heat exchanger 33, the heat medium three-way valve 34, the low temperature connection portion 38, the chiller 21, the low temperature flow rate adjustment unit 37, the bypass connection portion 35, and the low temperature pump 32 in this order. That is, in the low temperature circuit 31 in the independent circulation heating mode, the heat medium does not flow in and out through the heat-medium connection flow path 50, and the heat medium circulates in the low temperature circuit 31 independently from the others.

On the other hand, with respect to the high temperature circuit 41 of the heat medium circuit 30, the control device 70 determines the pressure feeding capability of the high temperature pump 42 so that the heating capacity necessary for achieving the target blowing temperature can be secured. At this time, the control device 70 controls the operation of the high temperature flow rate adjustment unit 44 so that the inflow/outflow ports of the first connection flow path 51 are brought into a fully closed state, and the heat-medium refrigerant heat exchanger 17 and the inflow/outflow ports of the high temperature connection portion 45 communicate with each other.

Accordingly, in the high temperature circuit 41 in the independent circulation heating mode, the heat medium flows and circulates through the high temperature pump 42, the heat-medium refrigerant heat exchanger 17, the heater core 43, the high temperature flow rate adjustment unit 44, the high temperature connection portion 45, and the high temperature pump 42 in this order. That is, in the high temperature circuit 41 in the independent circulation heating mode, the heat medium does not flow in and out through the heat-medium connection flow path 50, and the heat medium circulates in the high temperature circuit 41 independently from the others.

In the interior air conditioning unit 60, the control device 70 determines and controls the blowing capacity of an interior blower 62, the inside/outside air ratio of an inside/outside air switching device 63, and the ratio of an air mix door 64 in accordance with the operating condition set for the independent circulation heating mode.

Accordingly, in the independent circulation heating mode according to the fourth embodiment, the vehicle air conditioner 1 can pump up the heat absorbed from the heat medium by the chiller 21 by the heat pump cycle 10, and can use the heat for heating the blown air by the heater core 43 via the heat medium of the high temperature circuit 41. In the low temperature circuit 31, heat can be absorbed from the heat absorption source (outside air) into the heat medium through the outside air heat exchanger 33, and the heat of the heat medium can be absorbed into the refrigerant flowing through the chiller 21.

That is, in the independent circulation heating mode according to the fourth embodiment, as in the heat pump heating mode described above, heat absorbed by the low-pressure heat absorption unit 20 can be pumped up and used for heating the heating target (blown air) by the high-pressure heating unit 15. The independent circulation heating mode according to the fourth embodiment corresponds to an example of the independent circulation heating mode according to the present disclosure.

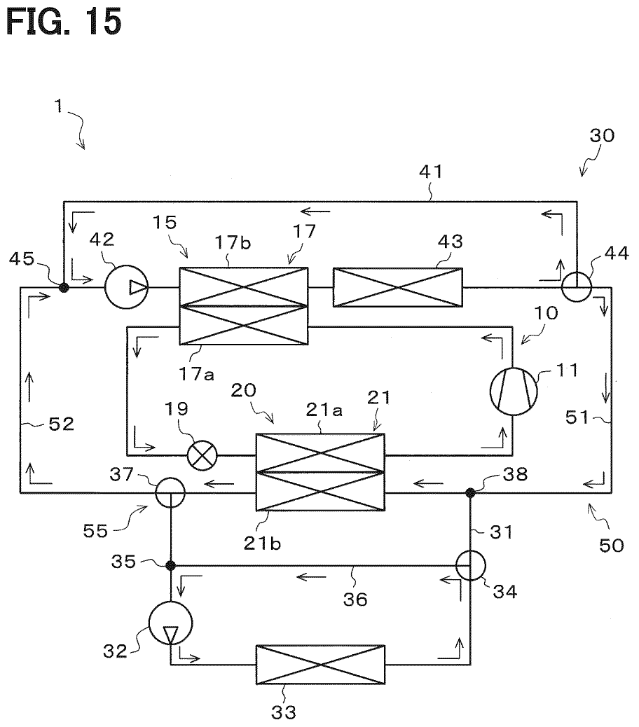

Next, the circuit cooperation heating mode in the vehicle air conditioner 1 according to the fourth embodiment will be described with reference to FIG. 15. The circuit cooperation heating mode according to the fourth embodiment is an operation mode in which part of the heat medium flowing through the high temperature circuit 41 is guided to the heat absorption unit 20 disposed on the low temperature to increase the amount of work done by the compressor 11 and heat the blown air.

The control device 70 causes the compressor 11 to compress and discharge the refrigerant, and brings the low temperature expansion valve 19 into a throttling state. Therefore, in the heat pump cycle 10 in the circuit cooperation heating mode, the circuit is switched to the refrigerant circuit in which the refrigerant flows and circulates through the compressor 11, the heat-medium refrigerant heat exchanger 17, the low temperature expansion valve 19, the chiller 21, and the compressor 11 in this order.

The control device 70 controls the refrigerant discharge performance of the compressor 11 and the throttle opening of the low temperature expansion valve 19 so as to have predetermined target values. The target values of the refrigerant discharge performance of the compressor 11 and the throttle opening of the low temperature expansion valve 19 can also be set, for example, in the same manner as in the independent circulation heating mode.

With respect to the low temperature circuit 31 of the heat medium circuit 30, the control device 70 controls the operation of the heat medium three-way valve 34 so that the outflow/inflow ports of the low temperature connection portion 38 are brought into a fully closed state, and the outside air heat exchanger 33 and the outflow/inflow ports of the heat medium bypass flow path 36 communicate with each other.

In addition, the control device 70 controls the operation of the low temperature flow rate adjustment unit 37 so that the inflow/outflow ports of the bypass connection portion 35 are brought into a fully closed state, and the chiller 21 and the inflow/outflow ports of the second connection flow path 52 communicate with each other. The control device 70 then determines the pressure feeding capability of the low temperature pump 32 to be in a state predetermined for the circuit cooperation heating mode.

As a result, in the low temperature circuit 31 in the circuit cooperation heating mode, the heat medium flows and circulates through the low temperature pump 32, the outside air heat exchanger 33, the heat medium three-way valve 34, the heat medium bypass flow path 36, the bypass connection portion 35, and the low temperature pump 32 in this order. That is, in the circuit cooperation heating mode, the low temperature circuit 31 is switched to a circuit configuration in which the heat medium circulates in part of the low temperature circuit 31 through the outside air heat exchanger 33 and the heat medium bypass flow path 36.

On the other hand, with respect to the high temperature circuit 41 of the heat medium circuit 30, the control device 70 determines the pressure feeding capability of the high temperature pump 42 so that the heating capacity necessary for achieving the target blowing temperature can be secured. At this time, the control device 70 controls the operation of the high temperature flow rate adjustment unit 44 so that all the inflow/outflow ports of the first connection flow path 51, the heat-medium refrigerant heat exchanger 17, and the high temperature connection portion 45 communicate with each other.

Accordingly, in the high temperature circuit 41 in the circuit cooperation heating mode, the heat medium branches into a flow circulating in the high temperature circuit 41 and a flow cooperating with the low temperature circuit 31 via the heat-medium connection flow path 50. In the flow circulating in the high temperature circuit 41, the heat medium flows and circulates through the high temperature pump 42, the heat-medium refrigerant heat exchanger 17, the heater core 43, the high temperature flow rate adjustment unit 44, the high temperature connection portion 45, and the high temperature pump 42 in this order.

In the flow cooperating with the low temperature circuit 31 via the heat-medium connection flow path 50, a circulation path via the heat medium passage 21b of the chiller 21 is configured via the heat-medium connection flow path 50 under the control of the low temperature flow rate adjustment unit 37 and the high temperature flow rate adjustment unit 44 described above. That is, the heat medium flows and circulates through the high temperature pump 42, the heat-medium refrigerant heat exchanger 17, the heater core 43, the high temperature flow rate adjustment unit 44, the first connection flow path 51, the low temperature connection portion 38, the chiller 21, the low temperature flow rate adjustment unit 37, the second connection flow path 52, and the high temperature connection portion 45 in this order.

In the interior air conditioning unit 60 in the circuit cooperation heating mode, the control device 70 determines and controls the blowing capacity of the interior blower 62, the inside/outside air ratio of the inside/outside air switching device 63, and the ratio of the air mix door 64 in accordance with the operating conditions set for the circuit cooperation heating mode.

Accordingly, in the circuit cooperation heating mode according to the fourth embodiment, the vehicle air conditioner 1 can cause part of the heat medium flowing through the high temperature circuit 41 to flow into the chiller 21 constituting the heat absorption unit 20 using the heat-medium connection flow path 50 and the heat medium flow rate adjustment unit 55.

In the chiller 21, heat is exchanged between the heat medium flowing in from the high temperature circuit 41 and the low-pressure refrigerant, so that the temperature of the low-pressure refrigerant in the heat pump cycle 10 can be increased. As the refrigerant temperature of the low-pressure refrigerant increases, the suction refrigerant density in the compressor 11 also increases. Therefore, the amount of work done by the compressor 11 can be increased, and the heating capacity of the heating target in the circuit cooperation heating mode can be increased. The circuit cooperation heating mode according to the fourth embodiment corresponds to an example of the circuit cooperation heating mode according to the present disclosure.

As described above, in the independent circulation heating mode, heat is absorbed from the heat absorption source (outside air) via the heat medium of the low temperature circuit 31, and the absorbed heat is pumped up by the heat pump cycle 10. The heat pumped up is released to the blown air as the heating target by the heater core 43 via the heat medium of the high temperature circuit 41, and the heating of the heating target is realized. Therefore, the heating capacity in the independent circulation heating mode according to the fourth embodiment is affected by the heat absorption amount in low temperature circuit 31 as in the heat pump heating mode according to the above-described embodiments.

On the other hand, in the circuit cooperation heating mode according to the fourth embodiment, the circuit configuration of the heat pump cycle 10 is similar to that in the independent circulation heating mode, but the configuration of the circulation path of the heat medium in the heat medium circuit 30 is different from that in the independent circulation heating mode.

As illustrated in FIG. 15, in the circuit cooperation heating mode, part of the heat medium flowing out of the heat-medium refrigerant heat exchanger 17 circulates through the heater core 43 in the high temperature circuit 41, but the other part of the heat medium flows through a path passing through the chiller 21 via the heat-medium connection flow path 50. That is, part of the heating capacity of the heat medium in the heat-medium refrigerant heat exchanger 17 is used for heating the heating target (blown air), and the other part of the heating capacity is used for the temperature rise of the low-pressure refrigerant via the chiller 21.

Before and after the switching from the independent circulation heating mode to the circuit cooperation heating mode, the heating capacity of the heat medium in the heat-medium refrigerant heat exchanger 17 is considered to be substantially the same without instantaneously increasing.

In a case where the mode shifts to the circuit cooperation heating mode, part of the heat medium flowing out of the heat-medium refrigerant heat exchanger 17 is used for heating the blown air via the heater core 43, but the other part of the heat medium is guided to the chiller 21 via the heat-medium connection flow path 50 and the heat medium flow rate adjustment unit 55. That is, since the blown air is heated by part of the heat amount of the heat medium heated by the heat of the high-pressure refrigerant in the heater core 43, it is considered that the heating capacity of the blown air temporarily decreases immediately after the switching from the independent circulation heating mode to the circuit cooperation heating mode.

The vehicle air conditioner 1 according to the fourth embodiment performs switching control for suppressing variation in heating capacity of a heating target due to a difference in operation mode at the time of switching from the independent circulation heating mode to the circuit cooperation heating mode.

As described above, since the heating capacity in each of the independent circulation heating mode and the circuit cooperation heating mode corresponds to the magnitude of the heat absorption amount in the heat absorption unit 20 and the magnitude of the amount of work done by the compressor 11, the heating capacities are affected by the pressure of the low-pressure refrigerant in the heat pump cycle 10. In order to suppress the fluctuation of the heating capacity at the time of mode switching and to make the fluctuation occur for a shorter period of time, it is desirable to quickly realize a state where the pressure of the low-pressure refrigerant is high from a state where the pressure of the low-pressure refrigerant required in the independent circulation heating mode is low in order to increase the amount of work done by the compressor 11 in the circuit cooperation heating mode.

In order to increase the pressure of the low-pressure refrigerant in the heat pump cycle 10, it is necessary to increase the amount of heat of the refrigerant. Therefore, as one of the operations in the switching control for increasing the pressure of the low-pressure refrigerant in the heat pump cycle 10 to suppress the fluctuation of the heating capacity, an operation of suppressing the amount of released heat of the high-pressure part of the heat pump cycle 10 is considered.

As a result, the amount of released heat of the high-pressure part of the heat pump cycle 10 is suppressed, so that the cycle is in a state where the heat that the refrigerant discharged from the compressor 11 has is secured. Therefore, the pressure of the low-pressure refrigerant in the heat pump cycle 10 can be increased. As a result, the pressure of the low-pressure refrigerant in the heat pump cycle 10 can be quickly raised to a desired state, and the fluctuation in heating capacity due to the switching of the operation mode can be quickly eliminated. Hereinafter, at the time of the switching control of the operation mode, the operation of suppressing the amount of released heat of the high-pressure part in the heat pump cycle 10 is referred to as a limiting operation.

As one of the operations in the switching control for increasing the pressure of the low-pressure refrigerant in the heat pump cycle 10 to suppress the fluctuation of the heating capacity, an operation of maintaining the heat absorption amount of the low-pressure part of the heat pump cycle 10 as much as possible is considered.

As described above, in the independent heating mode before switching, heat is absorbed through the heat medium of the heat medium circuit 30 in the low-pressure heat absorption unit 20 of the heat pump cycle 10. The amount of heat absorbed by the heat absorption unit 20 constitutes the amount of heat of the refrigerant flowing through the low-pressure flow path.

In consideration of this point, when the independent circulation heating mode is switched to the circuit cooperation heating mode, the heat absorption unit 20 continues to absorb heat from the independent circulation heating mode. However, the switching control at the time of switching the operation mode is performed within a range in which the heat absorption amount in the heat absorption unit 20 can be maintained, and a decrease in the pressure of the low-pressure refrigerant in the heat pump cycle 10 is suppressed. Hereinafter, an operation of maintaining the heat absorption amount of the low-pressure part of the heat pump cycle 10 as much as possible at the time of switching control of the operation mode is referred to as a heat absorption-amount securing operation.

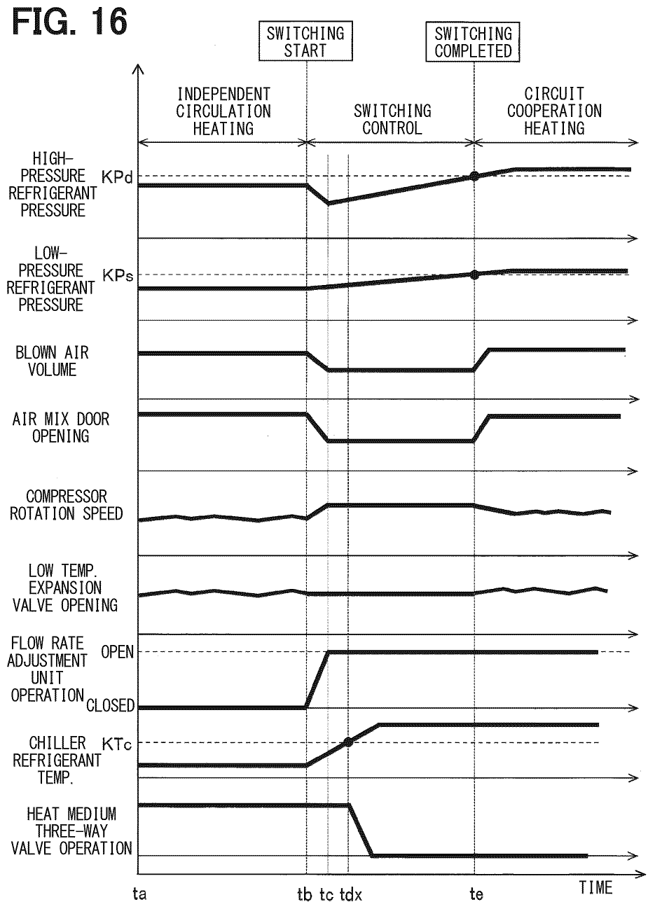

Next, in the vehicle air conditioner 1 according to the fourth embodiment, switching control at the time of switching from the independent circulation heating mode to the circuit cooperation heating mode, including the operation of each component, will be described in detail with reference to FIG. 16.

In the example illustrated in FIG. 16, the vehicle air conditioner 1 operates in the independent circulation heating mode after time ta. In the vehicle air conditioner 1 in the independent circulation heating, the control device 70 controls operations of the compressor 11, the low temperature expansion valve 19, the low temperature pump 32, the heat medium three-way valve 34, and the low temperature flow rate adjustment unit 37. Furthermore, the control device 70 controls operations of the high temperature pump 42, the high temperature flow rate adjustment unit 44, the interior blower 62, the air mix door 64, and the like.

In the fourth embodiment, switching of the operation mode from the independent circulation heating mode to the circuit cooperation heating mode is determined at time tb, and switching control in the vehicle air conditioner 1 is started. An example of the start condition of the switching control includes a case where the heat absorption amount from the heat absorption unit 20 is insufficient for the required heating capacity, and the independent circulation heating mode cannot cope with the required heating capacity. The relationship between the required heating capacity and the heat absorption amount is determined based on the relationship between the target blowing temperature as the air-conditioned air and the temperature of the heat absorption target (air) in the heat absorption unit 20.

When the switching control from the independent circulation heating mode to the circuit cooperation heating mode is started at time tb, operation aspects of the rotation speed of the compressor 11, the throttle opening of the low temperature expansion valve 19, the pressure feeding capability of the low temperature pump 32, the blowing capacity of the interior blower 62, and the opening of the air mix door 64 are controlled.

The rotation speed of the compressor 11 is adjusted from the rotation speed in the independent circulation heating mode to a predetermined rotation speed determined in the switching control. The throttle opening of the low temperature expansion valve 19 is switched from an aspect in which the throttle opening in the independent circulation heating mode fluctuates to an aspect in which a predetermined throttle opening determined in the switching control is maintained.

The control device 70 controls operations of the low temperature flow rate adjustment unit 37 and the high temperature flow rate adjustment unit 44 constituting the heat medium flow rate adjustment unit 55 to allow inflow and outflow of the heat medium between the low temperature circuit 31 and the high temperature circuit 41.

As a result, the heat pump cycle 10 at the time of the switching control is switched to the refrigerant circuit similar to that in the independent circulation heating mode although the refrigerant discharge performance of the compressor 11 and the decompression level of the low temperature expansion valve 19 are different.

In the heat medium circuit 30 at the time of the switching control, the circulation of the heat medium in the low temperature circuit 31 and the circulation of the heat medium in the high temperature circuit 41 in the independent circulation heating mode are continued, and at the same time, the inflow and outflow of the heat medium through the heat-medium connection flow path 50 are allowed.

As a result, in the high temperature circuit 41, part of the heat medium heated by the heat of the high-pressure refrigerant flows into the low temperature circuit 31 via the second connection flow path 52, and heat is absorbed by the low-pressure refrigerant in the chiller 21. Therefore, in the switching control, the operation of allowing the heat medium to flow in and out between the low temperature circuit 31 and the high temperature circuit 41 via the heat-medium connection flow path 50 in a state where the heat absorption unit 20 absorbs heat continuously from the independent circulation heating mode corresponds to an example of the heat absorption-amount securing operation.

That is, the heat absorption-amount securing operation according to the fourth embodiment can be referred to as an operation of securing a heat absorption amount with respect to the heat pump cycle 10 by the heat absorption amount from the heat absorption source (outside air) and the heat absorption amount from the heat medium derived from the high-pressure refrigerant (discharge refrigerant). Part of the heat medium flowing out of the chiller 21 flows into the high temperature circuit 41 via the first connection flow path 51, and the heat of the high-pressure refrigerant is released in the heat-medium refrigerant heat exchanger 17.

The blown air volume of the interior blower 62 is controlled to be a predetermined blown air volume with respect to the switching control, and operates so that the blown air volume maintains a predetermined value at the time of the switching control. Since the blown air volume of the interior blower 62 in the switching control is set to be lower than the blown air volume in the independent circulation heating mode, the blown air volume of the interior blower 62 is controlled to gradually decrease toward a predetermined value at the time of the switching control after passing time tb.

That is, in the switching control, the supply amount of the heating target (blown air) supplied to the heater core 43 constituting the heating unit 15 is limited by the operation control of the interior blower 62. Therefore, in the switching control, the operation of limiting the blowing capacity of the interior blower 62 to be lower than that in the independent circulation heating mode results in limiting the heat radiation destination of the high-pressure refrigerant, and thus corresponds to an example of the limiting operation in the switching control.

The opening of the air mix door 64 is controlled to be a predetermined value set so that the opening of the cold air bypass passage 65 is larger than that in the independent circulation heating mode. That is, at the time of the switching operation, the air mix door 64 is controlled so that most of the blown air having passed through the cooler core 33a flows while bypassing the heater core 43.

When the supply amount of the blown air supplied to the heater core 43 is limited to be lower than that in the independent circulation heating mode, the amount of released heat when the heat derived from the high-pressure refrigerant in the heat pump cycle 10 is released in the heating unit 15 is smaller than that in the independent circulation heating mode. Therefore, in the switching control, the operation of adjusting the opening of the air mix door 64 corresponds to an example of the limiting operation in the switching control.

As described above, when the operation control of each component related to the switching control is performed after passing time tb, the pressure of the high-pressure refrigerant in the heat pump cycle 10 decreases. In FIG. 16, a completion time point of various operations in the switching control is indicated as time tc.

After time tc, while the switching control is continued, the limiting operation and the heat absorption-amount securing operation described above are continued. Also in the fourth embodiment, in the switching control, a state in which the limiting operation and the heat absorption-amount securing operation are performed in parallel is referred to as a first state of the switching control.

Since the amount of released heat released from the high-pressure refrigerant in the heat pump cycle 10 is limited by the limiting operation, the value of the pressure of the high-pressure refrigerant increases with the lapse of time from the start of the limiting operation. That is, the heating capacity of the heat pump cycle 10 can be improved by the limiting operation in the switching control.

By the heat absorption-amount securing operation, the heat absorption amount in the heat absorption unit 20 in the low-pressure part of the heat pump cycle 10 indicates the heat absorption amount more than that in the independent circulation heating mode. This is because the heat medium heated by the heat of the high-pressure refrigerant is directly introduced into the heat medium passage 21b of the chiller 21 via the heat-medium connection flow path 50.

As a result, the pressure of the low-pressure refrigerant rapidly increases from the start of the heat absorption-amount securing operation. Similarly, the temperature (that is, the temperature of the low-pressure refrigerant flowing out of the refrigerant passage 21a of the chiller 21) of the low-pressure refrigerant flowing through the heat absorption unit 20 also rapidly increases after time tc. That is, by the heat absorption-amount securing operation in the switching control, the suction refrigerant density of the compressor 11 can be rapidly increased, and the amount of work done by the compressor 11 can be increased.

As the switching control, when the limiting operation and the heat absorption-amount securing operation are continuously performed after time tc, the refrigerant temperature in the refrigerant passage 21a of the chiller 21 reaches a predetermined reference chiller temperature KTc. That the refrigerant temperature in the refrigerant passage 21a of the chiller 21 is equal to or higher than a predetermined reference chiller temperature KTc is an example of the heat absorption stop condition.

In the fourth embodiment, the temperature of the low-pressure refrigerant in the refrigerant passage 21a of the chiller 21 is the reference chiller temperature KTc, and a time point at which the heat absorption stop condition is satisfied is referred to as time tdx. Time tdx indicates a time point at which the heat absorption amount in the heat absorption unit 20 cannot be sufficiently secured. Therefore, even when the heat absorption-amount securing operation is performed, it can be said that it is difficult to raise the temperature of the low-pressure refrigerant using the heat absorption amount.

In the heat absorption-amount securing operation of the fourth embodiment, heat absorption from the heat medium flowing in from the high temperature circuit 41 is performed in addition to heat absorption using outside air as a heat absorption source similar to that in the above-described embodiments. By using the heat medium from the high temperature circuit 41, the temperature of the low-pressure refrigerant can be more easily increased. That is, in the fourth embodiment, the time required after time tc to time tdx can be made shorter than the time required after time tc to time td in the above-described embodiments.

After passing time tdx, the heat absorption-amount securing operation is terminated. Specifically, with respect to heat absorption in the heat absorption unit 20 in the switching control, heat absorption from the outside air is stopped. For example, the operation of the heat medium three-way valve 34 is controlled so that the inflow/outflow ports of the low temperature connection portion 38 are brought into a fully closed state, and the outside air heat exchanger 33 and the inflow/outflow ports of the heat medium bypass flow path 36 communicate with each other. The operation of the low temperature flow rate adjustment unit 37 is controlled so that the inflow/outflow ports of the bypass connection portion 35 are brought into a fully closed state, and the chiller 21 and the inflow/outflow ports of the second connection flow path 52 communicate with each other.

As a result, since the embodiment is in an aspect in which the circulation path of the heat medium in the low temperature circuit 31 is switched to the circulation path through the outside air heat exchanger 33 and the heat medium bypass flow path 36, but not through the chiller 21, heat absorbed from the outside air as a heat absorption source is stopped. It is possible to adopt an aspect in which the low temperature pump 32 is stopped in order to stop heat absorption from the heat absorption source.

By stopping the heat absorption-amount securing operation at the time point at which the heat absorption stop condition is satisfied in this manner, it is possible to suppress waste of energy required for the heat absorption-amount securing operation and to realize switching control with high energy efficiency.

Even in a case where the heat absorption-amount securing operation is terminated, the circulation of the refrigerant and the heat medium and the limiting operation in the heat pump cycle 10 in the switching control are continuously performed. This state is referred to as a second state of the switching control. Since the limiting operation is continuously performed in the second state of the switching control, the pressure of the high-pressure refrigerant, the pressure of the low-pressure refrigerant, and the low-pressure refrigerant temperature in the heat pump cycle 10 increase with time even after time tdx and the end of the heat absorption-amount securing operation.

As described above, the switching control is performed in order to suppress the fluctuation of the heating capacity when the independent circulation heating mode is switched to the circuit cooperation heating mode. As one method of suppressing the fluctuation of the heating capacity, it is determined whether the pressure of the high-pressure refrigerant in the heat pump cycle 10 increases until the heating capacity in the circuit cooperation heating mode is equal to that in the independent circulation heating mode in the second state of the switching control.

Specifically, it is determined whether the pressure of the high-pressure refrigerant in the heat pump cycle 10 in the switching control is higher than the predetermined reference high pressure KPd. In a case where the pressure of the high-pressure refrigerant in the heat pump cycle 10 in the switching control is higher than the reference high pressure KPd, the heating capacity equivalent to that in the independent circulation heating mode can be exhibited in the circuit cooperation heating mode, so that the fluctuation of the heating capacity can be suppressed.

As another method of suppressing the fluctuation of the heating capacity at the time of switching to the circuit cooperation heating mode, it is conceivable to increase the amount of work done by the compressor 11 to a state equivalent to that of the heating capacity in the independent circulation heating mode in the second state of the switching control. That is, it is determined whether the pressure of the low-pressure refrigerant in the heat pump cycle 10 is higher than the reference low pressure KPs in the second state of the switching control.

The reference low pressure KPs indicates the pressure of the low-pressure refrigerant in the heat pump cycle 10, and is determined so that the amount of work done by the compressor 11 in the circuit cooperation heating mode is equal to that of the heating capacity in the independent circulation heating mode. In a case where the pressure of the low-pressure refrigerant in the heat pump cycle 10 of the switching control is higher than the reference low pressure KPs, the heating capacity equivalent to that in the independent circulation heating mode can be exhibited in the circuit cooperation heating mode, so that the fluctuation of the heating capacity can be suppressed.

As illustrated in FIG. 16, when the process shifts to the second state of the switching control after passing time tdx, the pressure of the high-pressure refrigerant and the pressure of the low-pressure refrigerant in the heat pump cycle 10 gradually increase. A time point when either a time point at which the pressure of the high-pressure refrigerant in the heat pump cycle 10 is equal to or higher than the reference high pressure KPd or a time point at which the pressure of the low-pressure refrigerant in the heat pump cycle 10 is equal to or higher than the reference low pressure KPs is established is defined as time te.

In the example illustrated in FIG. 16, a time point at which the pressure of the high-pressure refrigerant in the heat pump cycle 10 is equal to or higher than the reference high pressure KPd and a time point at which the pressure of the low-pressure refrigerant in the heat pump cycle 10 is equal to or higher than the reference low pressure KPs are simultaneously established, which is an example. Of the two conditions described above, a time point of the condition that is established earlier may be set as time te. Further, in view of reliably suppressing the fluctuation of the heating capacity, a time point at which both the condition of the pressure of the high-pressure refrigerant and the condition of the pressure of the low-pressure refrigerant are satisfied may be set as time te.

When the condition of the pressure of the high-pressure refrigerant or the condition of the pressure of the low-pressure refrigerant in the heat pump cycle 10 is satisfied and time te is passed, the switching control is terminated and the mode shifts to the circuit cooperation heating mode. By terminating the limiting operation and shifting to the circuit cooperation heating mode on condition that the condition of the pressure of the high-pressure refrigerant is satisfied, the circuit cooperation heating mode is started in a state where the heating capacity of the heat pump cycle 10 reaches a predetermined level (that is, the level before the switching control). Accordingly, the execution of the circuit cooperation heating mode can be started in a state where the fluctuation of the heating capacity of the blown air as the heating target is suppressed.

By terminating the limiting operation and shifting to the circuit cooperation heating mode on condition that the condition of the pressure of the low-pressure refrigerant is satisfied, the circuit cooperation heating mode is started in a state where the amount of work done by the compressor 11 reaches a predetermined level (that is, the level before the switching control). Even in this case, the execution of the circuit cooperation heating mode can be started in a state where the fluctuation in the heating capacity of the blown air as the heating target is suppressed.

As described above, according to the fourth embodiment, when the independent circulation heating mode is switched to the circuit cooperation heating mode, the switching control is performed to perform the limiting operation, so that the circuit cooperation heating mode can be started in a state where the heating capacity of the heat pump cycle 10 is sufficiently enhanced. This configuration achieves switching between the operation modes in a state where a difference in heating capacity due to the configuration of the refrigerant circuit between the independent circulation heating mode and the circuit cooperation heating mode is suppressed.

As illustrated in FIG. 16, as the limiting operation of the switching control, the operation of the interior blower 62 is controlled to limit the supply amount of the blown air to the heater core 43 constituting the heating unit 15. By limiting the blown air volume of the blown air by the interior blower 62, it is possible to limit the amount of released heat of the high-pressure part of the heat pump cycle 10 and improve the heating capacity of the high-pressure part of the heat pump cycle 10.

As a limiting operation of the switching control, the opening of the air mix door 64 is controlled to limit the supply amount of the blown air to the heater core 43 constituting the heating unit 15. According to the operation of the air mix door 64, the supply amount of the blown air as the heating target to the heater core 43 can be limited from the viewpoint of the air blowing path. Therefore, the heating capacity of the heat pump cycle 10 can be sufficiently secured before shifting to the circuit cooperation heating mode by the limiting operation related to the operation control of the air mix door 64.

As illustrated in FIG. 16, in the switching control, the limiting operation and the heat absorption-amount securing operation are performed in parallel. That is, by performing the limiting operation and the heat absorption-amount securing operation in parallel, it is possible to utilize both the viewpoint of the high-pressure heating capacity of the high-pressure part of the heat pump cycle 10 and the viewpoint of the amount of work done by the compressor 11 due to the low-pressure part of the heat pump cycle 10. Accordingly, in switching from the independent circulation heating mode to the circuit cooperation heating mode, the period during which the heating capacity of the heating target fluctuates can be further shortened, and the fluctuation can be suppressed to be a small level.

As in the independent circulation heating, the heat absorption-amount securing operation in the fourth embodiment is realized by absorbing heat from the heat medium flowing in from the high temperature circuit 41 via the heat-medium connection flow path 50 in parallel with the operation of absorbing heat from the heat absorption source (outside air) into the low-pressure refrigerant by the chiller 21. As a result, part of the heat of the discharged refrigerant discharged from the compressor 11 can be used in addition to the heat absorption source (outside air), so that the pressure of the low-pressure refrigerant in the heat pump cycle 10 can be increased in a shorter period of time to improve the amount of work done by the compressor 11.

As indicated by time tdx in FIG. 16, the heat absorption-amount securing operation in the switching control is terminated when the heat absorption stop condition is satisfied and the heat absorption amount is smaller than a predetermined reference. That is, in the switching control, the heat absorption-amount securing operation can be efficiently performed to suppress the fluctuation of the heating capacity.

As illustrated in FIG. 16, in a case where the heat absorption-amount securing operation is being performed and the heat absorption stop condition is satisfied, the supply amount of the heat medium circulating in the low temperature circuit 31 to the chiller 21 is set to 0. Specifically, the circulation path of the heat medium in the low temperature circuit 31 is switched, the heat medium passage 21b of the chiller 21 is excluded, and the circulation path is switched to the circulation path through the outside air heat exchanger 33 and the heat medium bypass flow path 36. Accordingly, the heat absorption-amount securing operation can be terminated by simple operation control.

As described above, in the vehicle air conditioner 1 according to the fourth embodiment, the limiting operation of limiting the amount of released heat in the heater core 43 constituting the heating unit 15 is performed in the switching control when the independent circulation heating mode is switched to the circuit cooperation heating mode. By performing the limiting operation by the switching control, the heating capacity of the heat pump cycle 10 with the high-pressure refrigerant can be sufficiently increased, and the fluctuation in the heating capacity between the independent circulation heating mode and the circuit cooperation heating mode can be suppressed to be a small level.

As illustrated in FIG. 16, as the limiting operation of the switching control, the operation of the interior blower 62 is controlled to limit the supply amount of the blown air to the heater core 43 constituting the heating unit 15. By limiting the blown air volume of the blown air by the interior blower 62, it is possible to limit the amount of released heat of the high-pressure part of the heat pump cycle 10 and improve the heating capacity of the high-pressure part of the heat pump cycle 10.

As a limiting operation in the switching control, the opening of the air mix door 64 is controlled to limit the supply amount of the blown air to the heater core 43 constituting the heating unit 15. According to the operation of the air mix door 64, the supply amount of the blown air as the heating target to the heater core 43 can be limited from the viewpoint of the air blowing path. Therefore, the heating capacity of the heat pump cycle 10 can be sufficiently secured before shifting to the circuit cooperation heating mode by the limiting operation related to the operation control of the air mix door 64.

As indicated by the period from time tc to time te in FIG. 16, the limiting operation in the switching control releases the limitation of the amount of released heat in a case where the pressure of the high-pressure refrigerant in the heat pump cycle 10 is equal to or higher than the reference high pressure KPd. The state in which the pressure of the high-pressure refrigerant is equal to or higher than the reference high pressure indicates a state in which the heating capacity of the heat pump cycle 10 is improved to a predetermined reference. Accordingly, in view of the heating capacity of heat pump cycle 10, the limiting operation is terminated in a state where the fluctuation in the heating capacity can be suppressed, and the mode can shift to the circuit cooperation heating mode.

The limiting operation in the switching control releases the limitation of the amount of released heat in a case where the pressure of the low-pressure refrigerant in the heat pump cycle 10 is equal to or higher than the reference low pressure KPs. A state in which the pressure of the low-pressure refrigerant is equal to or higher than the reference low pressure indicates a state in which the amount of work done by the compressor 11 increases to a predetermined reference. Accordingly, in view of the amount of work done by the compressor 11, the limiting operation is terminated in a state where the fluctuation in heating capacity can be suppressed, and the mode can shift to the circuit cooperation heating mode.

As illustrated in FIG. 16, in the switching control related to the switching from the independent circulation heating mode to the circuit cooperation heating mode, the limiting operation and the heat absorption-amount securing operation are performed in parallel, and then the mode shifts to the circuit cooperation heating mode. The heating capacity of heat pump cycle 10 can be improved by the limiting operation, and the amount of work done by the compressor 11 can be increased by the heat absorption-amount securing operation. Therefore, by performing the limiting operation and the heat absorption-amount securing operation in parallel, the required period of the switching control can be shortened, and the fluctuation in the heating capacity can be suppressed in a short period.

The present disclosure is not limited to the above-described embodiments, and can be variously modified as follows without departing from the gist of the present disclosure.

In the embodiments described above, the heat pump cycle device according to the present disclosure is applied to the vehicle air conditioner 1 mounted on an electric vehicle, but the application is not limited to this aspect. For example, the heating target in the heat pump cycle device according to the present disclosure is not limited to blown air to be air-conditioned. That is, the heat pump cycle device according to the present disclosure may be applied to, for example, a water heater using water as a heating target.

In the embodiments described above, examples of the heat absorption target and the heat absorption source in the heat pump cycle device include outside air and a heat medium, but the heat absorption target and the heat absorption source are not limited to this aspect. For example, exhaust heat of equipment mounted on an electric vehicle may be used as a heat absorption source, and exhaust heat generated in a battery, an inverter, a PCU, a transaxle, a control device for an ADAS, or the like may be used as a heat absorption source.

The inverter supplies power to a motor generator or the like. The PCU is a power control unit that performs transformation and power distribution. The transaxle is a power transmission mechanism in which a transmission, a differential gear, and the like are integrated. The control device for the ADAS is a control device for an advanced driver assistance system.

In the configuration of the heating unit 15 of the above-described embodiments, a configuration of directly radiating heat of the high-pressure refrigerant to the heating target as in the interior condenser 16, and a configuration of indirectly radiating heat of the high-pressure refrigerant to the heating target as in the heat-medium refrigerant heat exchanger 17 and the high temperature circuit 41 are used. That is, the heating unit 15 is only required to use heat of the high-pressure refrigerant for finally heating the heating target, and the embodiment does not limit the state on the way to the heating target.

In addition, examples of the configuration of the heat absorption unit 20 in the above-described embodiments include the configuration including the chiller 21 as the heat absorber, the configuration including the outside air heat absorber 22, and the configuration including the chiller 21 and the outside air heat absorber 22, but the configuration of the heat absorption unit 20 is not limited to this aspect. The heat absorption unit 20 is only required to be capable of absorbing heat from a heat absorption source, and may be configured by a greater number of heat absorbers.

In the above-described embodiments, as the end condition of the limiting operation, a case where the pressure of the high-pressure refrigerant is equal to or higher than the reference high pressure KPd and a case where the pressure of the low-pressure refrigerant is equal to or higher than the reference low pressure KPs are described. The reference high pressure KPd and the reference low pressure KPs are determined in consideration of the application of the vehicle air conditioner 1. That is, the reference high pressure KPd and the reference low pressure KPs are determined so as to change the heating capacity to such an extent that the occupant does not feel a large sense of discomfort due to the fluctuation of the heating capacity before and after the switching.

In the first and second embodiments described above, the heat pump cycle 10 is configured as a receiver cycle, and in the third embodiment, the heat pump cycle 10 is configured as an accumulator cycle, but the present invention is not limited to this aspect. As the heat pump cycle according to the present disclosure, the arrangement of the gas-liquid separation unit is not limited, and heat pump cycles having various configurations can be applied.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A heat pump cycle device comprising:
a compressor configured to compress and discharge a refrigerant;
a branch portion configured to branch a flow of the refrigerant discharged from the compressor;
a heating unit configured to heat a heating target using the refrigerant flowing out of one outflow port of the branch portion as a heat source;
a low temperature decompression unit configured to decompress the refrigerant flowing out of the heating unit;
a bypass passage configured to allow another portion of the refrigerant branched at the branch portion to flow through the bypass passage;
a bypass decompression unit configured to adjust a flow rate of the refrigerant flowing through the bypass passage;
a merging portion configured to merge a flow of the refrigerant flowing out of the bypass decompression unit and a flow of the refrigerant flowing out of the low temperature decompression unit to flow out toward a suction port of the compressor;
a heat absorption unit configured to cause at least the refrigerant flowing out of the low temperature decompression unit to absorb heat of a heat absorption target; and
a control unit including a processor with a memory storing program configured to cause the processor configured to execute control switching between a first heating mode and a second heating mode,
the first heating mode configured to
cause all of the refrigerant discharged from the compressor to flow into the heating unit via the branch portion, and
pump up heat absorbed from the heat absorption target in the heat absorption unit to heat the heating target,
the second heating mode configured to
cause a part of the refrigerant discharged from the compressor to flow into the bypass passage via the branch portion,
guide the refrigerant flowing out of the bypass decompression unit to the merging portion,
cause another part of the refrigerant discharged from the compressor to flow into the heating unit via the branch portion, and
cause the refrigerant flowing out of the heating unit to merge with a flow of the refrigerant from the bypass decompression unit at the merging portion to be sucked into the compressor, wherein
the control unit is configured to, when switching from the first heating mode to the second heating mode,
execute a limiting operation of limiting an amount of released heat in the heating unit in the first heating mode to a low level, and
complete the switching to the second heating mode after executing the limiting operation.

2. The heat pump cycle device according to claim 1, wherein
the heating unit includes a radiator configured to release heat of the refrigerant that has flowed into the heating unit, and a supply adjustment unit configured to adjust a supply amount of the heating target to be supplied to the radiator, and
the limiting operation includes controlling an operation of the supply adjustment unit to limit a supply amount of the heating target to the radiator to be lower than a predetermined reference amount.

3. The heat pump cycle device according to claim 1, wherein
the control unit is configured to, when a heating capacity of the heating unit exceeds a predetermined reference heating capacity during the limiting operation, terminate the limiting operation and release limitation of the amount of released heat in the heating unit.

4. The heat pump cycle device according to claim 1, wherein
the control unit is configured to, when a pressure of the refrigerant in the heat absorption unit exceeds a predetermined reference low pressure during the limiting operation, terminate the limiting operation and release limitation of the amount of released heat in the heating unit.

5. The heat pump cycle device according to claim 1, wherein
the control unit is configured to, when switching from the first heating mode to the second heating mode,
execute a heat absorption-amount securing operation in parallel with the limiting operation, the heat absorption-amount securing operation securing a heat absorption amount in the heat absorption unit using heat of the refrigerant discharged from the compressor and heat absorbed from the heat absorption target in the heat absorption unit, and
complete the switching to the second heating mode after executing the heat absorption-amount securing operation and the limiting operation.

6. A heat pump cycle device comprising:
a compressor configured to compress and discharge a refrigerant;
a branch portion configured to branch a flow of the refrigerant discharged from the compressor;
a heating unit configured to heat a heating target using the refrigerant flowing out of one outflow port of the branch portion as a heat source;
a low temperature decompression unit configured to decompress the refrigerant flowing out of the heating unit;
a bypass passage configured to allow another portion of the refrigerant branched at the branch portion to flow through the bypass passage;
a bypass decompression unit configured to adjust a flow rate of the refrigerant flowing through the bypass passage;
a merging portion configured to merge a flow of the refrigerant flowing out of the bypass decompression unit and a flow of the refrigerant flowing out of the low temperature decompression unit to flow out toward a suction port of the compressor;
a heat absorption unit configured to cause at least the refrigerant flowing out of the low temperature decompression unit to absorb heat of a heat absorption target; and
a control unit including a processor with a memory storing program configured to cause the processor to execute control switching between a first heating mode and a second heating mode,
the first heating mode configured to
cause all of the refrigerant discharged from the compressor to flow into the heating unit via the branch portion, and
pump up heat absorbed from the heat absorption target in the heat absorption unit to heat the heating target,
the second heating mode configured to
cause a part of the refrigerant discharged from the compressor to flow into the bypass passage via the branch portion,
guide the refrigerant flowing out of the bypass decompression unit to the merging portion,
cause another part of the refrigerant discharged from the compressor to flow into the heating unit via the branch portion, and
cause the refrigerant flowing out of the heating unit to merge with a flow of the refrigerant from the bypass decompression unit at the merging portion to be sucked into the compressor, wherein
the control unit is configured to, when switching from the first heating mode to the second heating mode,
execute a heat absorption-amount securing operation of securing a heat absorption amount in the heat absorption unit using heat of the refrigerant discharged from the compressor and heat absorbed from the heat absorption target in the heat absorption unit, and
complete the switching to the second heating mode after executing the heat absorption-amount securing operation.

7. The heat pump cycle device according to claim 6, wherein
the heat absorption-amount securing operation is configured to
continue absorbing heat from the heat absorption target in the heat absorption unit while operating in the first heating mode, and simultaneously,
cause a part of the refrigerant discharged from the compressor to flow into the bypass passage via the branch portion and guide the refrigerant flowing out of the bypass decompression unit to the merging portion.

8. The heat pump cycle device according to claim 6, wherein
the control unit is configured to reduce heat absorption in the heat absorption unit when a heat absorption stop condition is satisfied during the heat absorption-amount securing operation, the heat absorption stop condition is a condition that a heat absorption amount absorbed by the refrigerant from the heat absorption target in the heat absorption unit is lower than a predetermined reference heat absorption amount.

9. The heat pump cycle device according to claim 8, wherein
the control unit is configured to reduce heat absorption in the heat absorption unit by reducing a supply amount of the heat absorption target to the heat absorption unit when the heat absorption stop condition is satisfied during the heat absorption-amount securing operation.

10. The heat pump cycle device according to claim 8, further comprising
a refrigerant bypass flow path through which a flow of the refrigerant flowing out of the heating unit bypasses the heat absorption unit and is guided to the merging portion, wherein
the control unit is configured to reduce heat absorption in the heat absorption unit by stopping a supply of the refrigerant to the heat absorption unit using the refrigerant bypass flow path when the heat absorption stop condition is satisfied during the heat absorption-amount securing operation.

11. A heat pump cycle device comprising:
a heat pump cycle including
a compressor configured to compress and discharge a refrigerant,
a heat-medium refrigerant heat exchanger configured to release heat of a high-pressure refrigerant discharged from the compressor to a heat medium,
a decompression unit configured to decompress the refrigerant flowing out of the heat-medium refrigerant heat exchanger, and
a chiller configured to cause the refrigerant to absorb heat via heat exchange between the refrigerant decompressed by the decompression unit and the heat medium;
a heat medium circuit including
a first circuit configured to allow the heat medium flowing out of the heat-medium refrigerant heat exchanger to circulate through the first circuit, the first circuit including a heat medium radiator configured to release heat of the heat medium to a heating target,
a second circuit configured to allow the heat medium flowing through the chiller to circulate through the second circuit, the second circuit including a heat medium heat absorber configured to absorb heat from a heat absorption target via heat exchange with the heat medium,
a heat-medium connection flow path connected between the first circuit and the second circuit so that the heat medium is allowed to flow in and out, and
a flow rate adjustment unit configured to adjust a flow rate of the heat medium flowing in and out between the first circuit and the second circuit via the heat-medium connection flow path; and
a control unit including a processor with a memory storing program configured to cause the processor to execute control switching between an independent circulation heating mode and a circuit cooperation heating mode,
the independent circulation heating mode configured to
cause the heat medium to independently circulate through the second circuit and absorb heat derived from the heat absorption target to be pumped up by the heat pump cycle, and
cause the heat medium to independently circulate through the first circuit and heat the heating target in the heat medium radiator using the heat pumped up,
the circuit cooperation heating mode configured to
cause a part of the heat medium flowing out of the heat-medium refrigerant heat exchanger to flow through the chiller via the heat-medium connection flow path, and
cause another part of the heat medium flowing out of the heat-medium refrigerant heat exchanger to circulate through the first circuit via the heat medium radiator to heat the heating target in the heat medium radiator, wherein
the control unit is configured to, when switching from the independent circulation heating mode to the circuit cooperation heating mode,
execute a limiting operation of limiting an amount of released heat in the heat medium radiator in the independent circulation heating mode to a low level, and
complete the switching to the circuit cooperation heating mode after executing the limiting operation.

12. The heat pump cycle device according to claim 11, further comprising
a supply adjustment unit configured to adjust a supply amount of the heating target to be supplied to the heat medium radiator, wherein the limiting operation includes controlling an operation of the supply adjustment unit to limit a supply amount of the heating target to the heat medium radiator to be lower than a predetermined reference amount.

13. The heat pump cycle device according to claim 11, wherein
the control unit is configured to, when a heating capacity of the heat medium circulating through the first circuit exceeds a predetermined reference during the limiting operation, terminate the limiting operation and release limitation of the amount of released heat in the heat medium radiator.

14. The heat pump cycle device according to claim 11, wherein
the control unit is configured to, when a pressure of the refrigerant in the chiller exceeds a predetermined reference low pressure during the limiting operation, terminate the limiting operation and release limitation of the amount of released heat in the heat medium radiator.

15. The heat pump cycle device according to claim 11, wherein
the control unit is configured to, when switching from the independent circulation heating mode to the circuit cooperation heating mode,
execute a heat absorption-amount securing operation in parallel with the limiting operation, the heat absorption-amount securing operation securing a heat absorption amount in the chiller using heat absorbed from the heat absorption target in the heat medium heat absorber and heat of the heat medium guided from the first circuit to the chiller via the heat-medium connection flow path, and
complete the switching to the circuit cooperation heating mode after executing the heat absorption-amount securing operation and the limiting operation.
